(19) United States
(12) Patent Application Publication
(10) Pub. No.: US 2013/0110992 A1
(43) Pub. Date: May 2, 2013

(54) ELECTRONIC DEVICE MANAGEMENT USING INTERDOMAIN PROFILE-BASED INFERENCES

(71) Applicants: Oka Anand Ravindra, Waterloo (CA); Simmons Sean Bartholomew, Waterloo (CA); Snow Christopher Harris, Waterloo (CA)

(72) Inventors: Oka Anand Ravindra, Waterloo (CA); Simmons Sean Bartholomew, Waterloo (CA); Snow Christopher Harris, Waterloo (CA)

(73) Assignee: RESEARCH IN MOTION LIMITED, Waterloo, ON (CA)

(21) Appl. No.: 13/634,536

(22) PCT Filed: Oct. 28, 2011
(86) PCT No.: PCT/CA2011/050679

§ 371 Date: Sep. 12, 2012

(51) Int. Cl. G06F 15/177

(52) U.S. Cl. 709/220

(57) ABSTRACT

A system and method for generating action cues and recommendations for provision to an electronic device are provided. Context data associated with an electronic device and derived from one or more of sensor data, device state data, and application data is received, and a profile for the electronic device or a user thereof is defined using the context data, representing probability distribution. A selected action from a plurality of actions executable at the electronic device is identified using the profile, and a cue is returned to the electronic device for execution. The profile may be constructed as a factor graph representation using random coding techniques.

### BACKGROUND

1. Technical Field

The present disclosure relates generally to management of electronic device functions using inferences derived from an associated interdomain profile.

2. Description of the Related Art

Mobile computing is often performed under constraints not present under desktop computing conditions. Typical mobile computing tasks are frequently dependent on a current location and/or state of the mobile device user, and the mobile computing device platform is typically subject to physical limitations that desktop (or less portable) computing platforms are not. For example, a mobile computing device, such as a tablet computer or smartphone, typically has a smaller form factor than a desktop computer, and is more likely to present a restricted user interface with more challenging ergonomics: a smaller or virtual keyboard, smaller display screen, and lower quality speakers or microphones.

Improving user interaction with a mobile computing device therefore typically involves improvement of the existing physical user interface devices available on the device. Such improvements, while they may improve the ergonomics or intuitiveness of the user interface, do not necessarily reduce the amount of physical interaction the user must have with the device in order to achieve the desired results.

### BRIEF DESCRIPTION OF THE DRAWINGS

The drawings illustrate example embodiments of the present disclosure.

FIG. 1 is a block diagram of an example embodiment of an electronic device such as a mobile computing device.

FIG. 2 is a schematic diagram illustrating an overview of a relationship between a user and a plurality of second entities.

FIG. 3 is a schematic diagram of a factor graph description of a first entity.

FIG. 4 is a schematic diagram of a factor graph description of a second entity.

FIG. 4A is a schematic diagram of a factor graph description of a plurality of second entities.

FIG. 5 is a schematic diagram of a merged factor graph description of a first entity and multiple second entities.

FIG. 6 is a flowchart illustrating a method for constructing a factor graph.

FIG. 7 is a schematic diagram depicting select components of the electronic device of FIG. 1 and select components of a profile service.

FIG. 8 is a schematic diagram depicting select components of an electronic device including the profile service.

FIG. 9 is a schematic diagram illustrating a network topology for use in generating and maintaining profile data, generating inferences, and providing action cues to an electronic device.

FIG. 10 is a flowchart illustrating an overview of a method for updating a user or device profile.

FIG. 11 is a communication flow diagram illustrating interaction between an electronic device and a profile service.

FIG. 12 is a communication flow diagram further illustrating interaction between an electronic device and a profile service.

FIG. 13 is a schematic diagram illustrating a further network topology for use in generating and maintaining profile data, generating inferences, and providing action cues to an electronic device.

FIG. 14 is still a further communication flow diagram illustrating interaction between an electronic device and profile service over the network of FIG. 13.

FIG. 15 is flowchart illustrating a method for executing feedback and query functions with the profile service.

### DETAILED DESCRIPTION

The example embodiments described herein provide a system and method arranged to provide enhanced operation and management of electronic device functions using inferences derived from an associated interdomain profile.

There is thus provided an example embodiment method for managing electronic device functions using inferences derived from an associated interdomain profile, the method comprising: defining a profile for an electronic device using context data aggregated from at least one electronic device and a plurality of domains and including one or more of sensor data, device state data, and application data, the profile including a representation of a probability distribution for the electronic device, identifying, using the profile, one of a plurality of actions associated with one or more applications for implementation at the electronic device, and providing a cue for said action to the electronic device.

In one example aspect, the action includes a user-initiable command, and the cue includes a parameter associated with the user-initiable command.

In another example aspect, the context data includes two or more of sensor data, device state data, and application data.

In still another example aspect, the plurality of domains is selected from a messaging domain, a social networking domain, a consumer preference domain, and an environmental domain.

In a further example aspect, the application data is selected from search application search terms, contacts, message keywords, social networking post keywords, weather forecast data, application identifiers, message senders, message recipients, message characteristics, message handling data, and media files selected for playback.

In still a further example aspect, the sensor data is selected from geographic location data, ambient light, time of day, accelerometer data, and proximity sensor data.

In another example aspect, the device state data is selected from battery level, wireless network connection, radio state, attachment of peripherals, screen brightness, speaker volume, data transfer levels, docked state, and charging state.

In still another example aspect, the context data includes historical data.

In a further example aspect, the representation of the probability distribution includes a factor graph representation having factors dependent on at least one of a set of characteristic variables associated with the electronic device.

In still a further example aspect, defining the factor graph representation comprises: adding to the factor graph representation a selected one of the factors, the selected factor having a degree d, selecting d of the set of characteristic variables and connecting the d characteristic variables to at least one of the factors added to the factor graph, and repeating the adding and selecting until each of the factors is connected to a number of characteristic variables equal to its degree.

In another example aspect, the selected one of the factors is a factor having a high probability of a low degree d.

In still another example aspect, selecting d of the set of characteristic variables comprises preferentially selecting those characteristic variables that are either currently unconnected or have low connectivity to the at least one of the factors currently added to the factor graph.

In a further example aspect, at least one of the selected factor and the d of the set of characteristic variables is randomly selected.

In still a further example aspect, identifying the one of the plurality of actions includes inferring the one of the plurality of actions using the profile and at least one received context value associated with the electronic device.

In another example aspect, the at least one received context value is either a sensor value or a device state value.

In still another aspect, the application associated with the identified action includes a media player, and the action includes the media player playing a selected media file.

In a further example aspect, the application associated with the identified action includes a messaging application, and the action includes marking a received message as important.

In still a further example aspect, the application associated with the identified action includes a search application, and the action includes initiating a search with a selected search parameter.

In another example aspect, the context data is aggregated from a domain or domains other than a domain associated with the application associated with the identified action.

In still another example aspect, the methods described may be implemented at the electronic device.

In a further example aspect, the methods described may be implemented at a server systems in communication with the electronic device over a network.

There is also provided an example embodiment communication device or other electronic device adapted to carry out the above-described methods. In particular, there is also provided an example embodiment communication device comprising a memory, a communication subsystem, and at least one processor in communication with the memory and the communications subsystem, the processor being adapted to: define a profile for an other electronic device using context data aggregated from at least one electronic device and a plurality of domains and including one or more of sensor data, device state data, and application data, the profile including a representation of a probability distribution for the other electronic device, identifying, using the profile, one of a plurality of actions associated with one or more applications for implementation at the other electronic device, and providing a cue for said action to the other electronic device.

In one example aspect of the communication device described, the action includes a user-initiable command, and the cue includes a parameter associated with the user-initiable command.

In another example aspect of the communication device described, the at least one processor is further adapted such that the context data includes two or more of sensor data, device state data, and application data.

In still another example aspect of the communication device described, the at least one processor is further adapted to select the plurality of domains from a messaging domain, a social networking domain, a consumer preference domain, and an environmental domain.

In a further example aspect of the communication device described, the at least one processor is further adapted to select the application data from search application search terms, contacts, message keywords, social networking post keywords, weather forecast data, application identifiers, message senders, message recipients, message characteristics, message handling data, and media files selected for playback.

In still a further example aspect of the communication device described, the at least one processor is further adapted to select the sensor data from geographic location data, ambient light, time of day, accelerometer data, and proximity sensor data.

In another example aspect of the communication device described, the at least one processor is further adapted to select the device state data from battery level, wireless network connection, radio state, attachment of peripherals, screen brightness, speaker volume, data transfer levels, docked state, and charging state.

In still another example aspect of the electronic device described, the context data includes historical data.

In a further example aspect of the communication device described, the representation of the probability distribution includes a factor graph representation having factors dependent on at least one of a set of characteristic variables associated with the other electronic device.

In still a further example aspect of the communication device described, the at least one processor is further adapted to define the factor graph representation by: adding to the factor graph representation a selected one of the factors, the selected factor having a degree d, selecting d of the set of characteristic variables and connecting the d characteristic variables to at least one of the factors added to the factor graph, and repeating the adding and selecting until each of the factors is connected to a number of characteristic variables equal to its degree.

In another example aspect of the communication device described, the selected one of the factors is a factor having a high probability of a low degree d.

In still another example aspect of the communication device described, the at least one processor is further adapted such that selecting d of the set of characteristic variables comprises preferentially selecting those characteristic variables that are either currently unconnected or have low connectivity to the at least one of the factors currently added to the first factor graph.

In a further example aspect of the communication device described, the at least one processor is further adapted to randomly select at least one of the selected factor and the d of the set of characteristic variables.

In still a further example aspect of the communication device described, the at least one processor is further adapted to identify the one of the plurality of actions by inferring the one of the plurality of actions using the profile and at least one received context value associated with the other electronic device.

In another example aspect of the communication device described, the at least one received context value is either a sensor value or a device state value.

In still another example aspect of the communication device described, the application associated with the identified action includes a media player, and the action includes the media player playing a selected media file.

In a further example aspect of the communication device described, the application associated with the identified action includes a messaging application, and the action includes marking a received message as important.

In still a further example aspect of the communication device described, the application associated with the identified action includes a search application, and the action includes initiating a search with a selected search parameter.

In another example aspect of the communication device described, the context data is aggregated from a domain or domains other than a domain associated with the application associated with the identified action.

These example embodiments are described generally in the context of a user mobile computing device in communication with an online (e.g., cloud-based) service, although those skilled in the art will appreciate that alternate implementations are possible, including solely user device-based implementations. Further, those skilled in the art will appreciate that implementation of these example embodiments is not restricted to mobile computing devices, but may be implemented using other data processing devices. Generally, the data processing device may include electronic devices such as servers, personal computers, or other data processing or communication devices such as wireless communication devices communicating over fixed and wireless networks and public networks. However, this description is not intended to limit the scope of the described example embodiments to implementation on a networked or networking-capable electronic device or system. For example, the methods and systems described herein may be applied to any appropriate data processing device, whether portable or wirelessly enabled or not, whether provided with voice communication capabilities or not, and adapted to process data and carry out operations on data in response to user commands for any one or a number of purposes, including productivity and entertainment. Thus, the example embodiments described herein may be implemented on electronic devices such as cellular phones, smartphones, wireless organizers, personal digital assistants, desktop computers, terminals, laptops, tablets, handheld wireless communication devices, notebook computers, entertainment devices such as MP3 or video players, and the like. Unless expressly stated, a data processing or electronic device can be a device such as any of the above.

In the examples described herein, communication takes place over a public network (such as the Internet or a similar), adapted to implement the Internet Protocol Suite as defined in RFC 1122 as published by the Internet Engineering Task Force, and optionally its predecessor, successor, and accompanying or complementary standards. For example, communication may take place over an Internet Protocol (IP) network implementing the Transmission Control Protocol (i.e., a TCP/IP network). Reference to a TCP/IP-based communication system is made due to its prevalence; other protocols such as the User Datagram Protocol (UDP) may be implemented over an IP network. Again, however, the person skilled in the art will appreciate that the example embodiments described herein may be applied in environments and on networks implementing different communication protocols for formatting, addressing, transmitting and routing data.

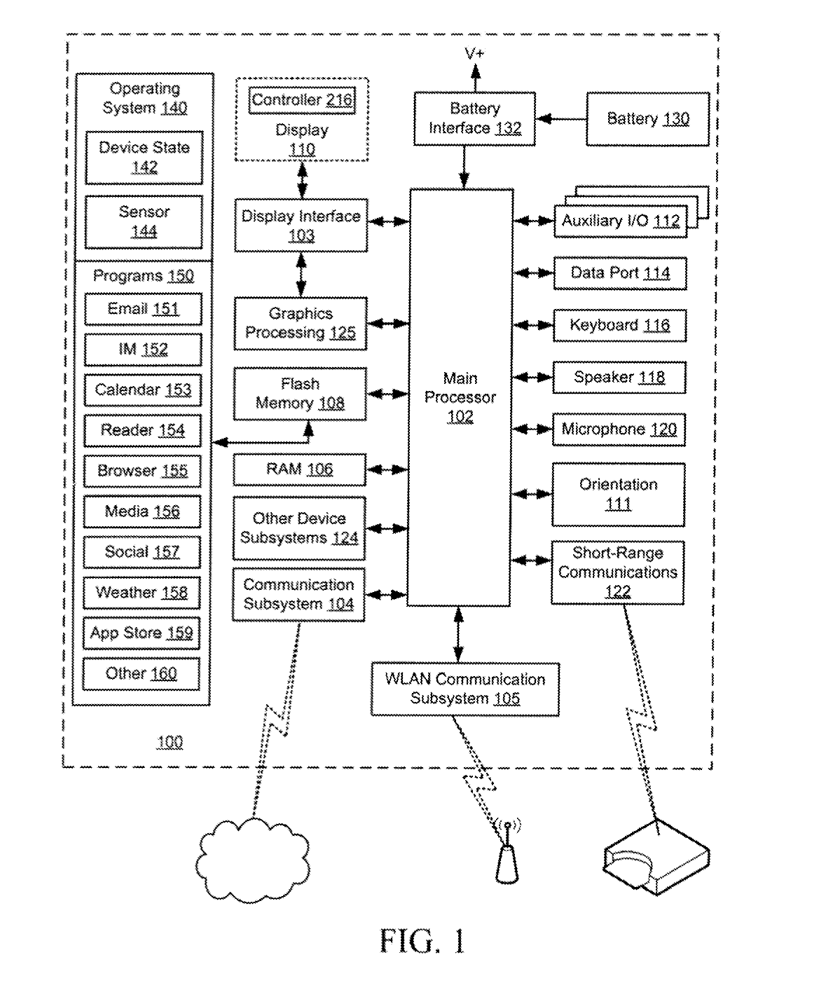

FIG. 1 is a block diagram of an example embodiment of an electronic device 100 that may be used with the example embodiments described herein. The electronic device 100 includes a number of components such as a main processor 102 that controls the overall operation of the electronic device 100. It should be understood that the components described in FIG. 1 are optional and that an electronic device used with various example embodiments described herein may include or omit components described in relation to FIG. 1.

The electronic device 100 may be a battery-powered device including a battery interface 132 for receiving one or more rechargeable batteries 130. Communication functions, including data and voice communications, are performed through one or more communication subsystems 104, 105, and/or 122 in communication with the processor 102. Data received by the electronic device 100 can be decompressed and decrypted by a decoder, operating according to any suitable decompression techniques, and encryption/decryption techniques according to one or more various encryption or compression standards known to persons of skill in the art.

If equipped with a communication subsystem 104, this subsystem 104 receives data from and sends data to a wireless network. In this example embodiment of the electronic device 100, the communication subsystem 104 is configured in accordance with one or more wireless communications standards. New wireless communications standards are still being defined, but it is believed that they will have similarities to the network behaviour described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for the wireless communications standard, and optionally other network communications.

The electronic device 100 may be provided with other communication subsystems, such as a wireless LAN (WLAN) communication subsystem 105 or a short-range and/or near-field communications subsystem 122 also shown in FIG. 1. The WLAN communication subsystem 105 may operate in accordance with a known network protocol such as one or more of the 802.11™ family of standards developed or maintained by IEEE. The communications subsystems 105 and 122 provide for communication between the electronic device 100 and different systems or devices without the use of the wireless network 200, over varying distances that may be less than the distance over which the communication subsystem 104 can communicate with the wireless network 200. The subsystem 122 can include an infrared device and associated circuits and/or other components for short-range or near-field communication.

The communication subsystem component 104, 105, 122 may include a receiver, transmitter, and associated components such as one or more embedded or internal antenna elements, Local Oscillators (LOs), and a processing module such as a Digital Signal Processor (DSP) in communication with the transmitter and receiver. The particular design of the communication subsystems 104, 105, 122, or other communication subsystem is dependent upon the communication network 200 with which the electronic device 100 is intended to operate. Thus, it should be understood that this description serves only as one example. It should be understood that any of the communication subsystems 104, 105, 122 may optionally be included in the electronic device 100. Alternatively, a communication subsystem provided in a dongle or other peripheral device (not shown) may be connected to the electronic device 100, either wirelessly or by a fixed connection such as a USB port, to provide the electronic device 100 with access to a network. If provided onboard the electronic device 100, the communication subsystems 104, 105 and 122 may be separate from, or integrated with, each other.

The main processor 102 also interacts with additional subsystems such as a Random Access Memory (RAM) 106, a flash memory 108, a display interface 103, other data and memory access interfaces such as an auxiliary input/output (I/O) subsystem 112 or a data port 114, a keyboard 116, a speaker 118, a microphone 120, the short-range communications 122 and other device subsystems 124. The communication device may also be provided with an accelerometer 111, which may be used to detect gravity- or motion-induced forces and their direction. Detection of such forces applied to the electronic device 100 may be processed to determine a response of the electronic device 100, such as an orientation of a graphical user interface displayed on the display 110 in response to a determination of the current orientation of the electronic device 100.

In some example embodiments, the electronic device 100 may include an integral display screen 110, shown in phantom in FIG. 1. For example, a handheld or portable electronic device 100 such as a tablet, laptop, or smartphone typically incorporates a display screen 110 in communication with the main processor 102 via the display interface 103, whereas other electronic devices 100 are connected to external monitors or screens using the display interface 103, as in the case of a desktop computer. However, smaller devices, such as the tablet, laptop or smartphone, may also be connected to external monitors or screens, in which case the display interface 103 represented in FIG. 1 includes an interface for connection of an external display device.

Further, in some example embodiments, the display 110 may be a touchscreen-based device, in which the display 110 is a touchscreen interface that provides both a display for communicating information and presenting graphical user interfaces, as well as an input subsystem for detecting user input that may be converted to instructions for execution by the device 100. The display 110 may thus be the principal user interface provided on the electronic device 100, although in some example embodiments, additional buttons, variously shown in the figures or a trackpad, or other input means may be provided. If a touchscreen is provided, then other user input means such as the keyboard 116 may or may not be present. The controller 216 and/or the processor 102 may detect a touch by any suitable contact member on the touch-sensitive display 110.

When a user specifies that a data file is to be outputted to the display interface 103, the data file is processed for display by the main processor 102. This processing may include, in the case of structured documents, parsing of the document to render the document or a portion thereof as an image file, which is then provided as output to the display interface 103 as discussed below. The main processor 102 may thus include a visualization subsystem, implemented in hardware, software, or a combination thereof, to process the data file for display.

Depending on the input data file, the processing carried out by the processor 102 in preparation for display may be relatively intensive, and the processing may consume a significant amount of processor time and memory. In particular, processing data files originally optimized or prepared for visualization on large-screen displays on a portable electronic device display often requires additional processing prior to visualization on the small-screen portable electronic device displays. Thus, the electronic device 100 may also be provided with a graphics processor module 125 separate from the main processor 102, again implementable in hardware, software, or a combination thereof. The graphics processor module 125 may include a dedicated image processor with associated circuitry, including memory that is separate from other memory in the electronic device 100, such as the RAM 106, flash memory 108, and any memory internal to the main processor 102. The operation of such graphics processor modules will be known to those skilled in the art. Upon an application processing data file for display determining that the file includes content or transformations that are appropriately handled by the graphics processor module 125, those components of the file are provided to the graphics processor module 125 with associated commands for the rendering of that content for output to the display interface 103. The graphics processor module 125 can be configured to retrieve image files stored in device memory (such as RAM 106 or flash memory 108), or in its own resident memory, and to apply these image files as texture maps to surfaces defined in accordance with the received commands.

The electronic device 100 also includes an operating system 140 and software components 142 to 160 which are described in more detail below. It will be understood by those skilled in the art that for ease of exposition, only select operating system and program components are illustrated in FIG. 1. The operating system 140 and the software components 142 to 160 that are executed by the main processor 102 are typically stored in a persistent store such as the flash memory 108, which can alternatively be a read-only memory (ROM) or similar storage element (not shown). Those skilled in the art will appreciate that portions of the operating system 140, such as the device state module(s) 142 and sensor module(s) 144, and the further software components 150 to 160, such as specific device applications, or parts thereof, can be temporarily loaded into a volatile store such as the RAM 106. Other software components can also be included, as is well known to those skilled in the art.

The subset of software applications or components that control basic device operations, including data and voice communication applications, will normally be installed on the electronic device 100 during its manufacture and may be included with the operating system 140, although in some example embodiments these components may be provided and installed separately. Thus, the device state module 142, which provides persistence (e.g., ensuring that important data is persisted in non-volatile memory and is not lost when the electronic device 100 is turned off or loses power), and the device sensor module or modules 144, which monitor changes of state of one or more device sensors and provide signals to other modules (e.g., other operating system modules, device hardware, and/or software applications) regarding detected device sensor data, are depicted in FIG. 1 as components of the operating system 140, although in some example embodiments these components may be more appropriately considered to be included with the device programs 150.

Programs 150 that may be provided for execution by the electronic device 100 can include messaging applications, including one or more of email programs 151 or one or more instant messaging (IM) programs 152. Other messaging applications for different messaging platforms, such as SMS, private or network messages, and the like, may also be included with the programs 150, as well as a unified message box application or function that provides a unified view of message or other content information associated with multiple user accounts or message types, and which serves as an entry point for access to other messaging services or applications executable on the device 100. The “unified message box” may also be known as a “unified inbox”; however, a unified message box in particular may contain inbound messages, outbound messages, or a combination thereof.

Productivity applications such as calendar applications 153, word processors, document viewers, spreadsheet programs, accounting programs, and the like may also be included, as well as other applications that may be used for productivity, entertainment or information purposes, such as feed/content readers 154, web browsers 155, media players 156 (which can include picture viewers, music players, and/or video players), social networking applications 157 (which can include messaging functions), news, weather, and other “ticker” applications 158. Further, other applications, such as the app store application 159, may be provided on the electronic device 100 to manage and track the download and installation of individual applications or applets on the electronic device 100. The app store application 159 may interface over a network with a single repository of available electronic device applications. The app store application 159 may further track the availability of updates for electronic device applications previously downloaded using the app store application 159 and present notifications at the electronic device 100 when updates are available for download. A variety of other device programs 160 may also be provided for execution on the device 100. Each of the applications 150 may be provided with a corresponding data store at the device 100 (for example, in the flash memory 108).

The individual applications 150 and operating system 140 components may be provided with associated data stores on the electronic device 100, typically in persistent memory such as the flash memory 108. Thus, for example, messages that have been sent or received by the user are typically stored in whole or in part in the flash memory 108 of the electronic device 100, and recently read content or webpages may be cached on the device 100 either in flash memory 108 or in RAM 106 for at least a current session of the reader 154 or browser application 155. In at least some example embodiments, some data generated and/or accessed by the various programs 150 or operating system 140 components can be stored at a remote location from the electronic device 100 such as in a data store of an associated host system (not shown in FIG. 1) with which the electronic device 100 communicates.

User experience with the electronic device 100 generally benefits from enhancements such as a natural and/or intuitive user interface, and a device response to user commands or actions that is not only quick and intelligent, but also relevant to the user's current state. This is particularly important in the case of mobile computing devices since, as noted above, mobile computing devices typically present physical constraints to the design of user interfaces: the smaller form factor of smartphones and tablet computers limits display screen size and the number of physical input devices that may be integrated into the device chassis. Further, the user herself is often subject to constraints or impediments when operating a mobile device, by virtue of its mobility: a mobile computing device is more likely than a desktop computer to be brought to a location with weak wireless network signal strength, used in transit, or carried into an environment with low ambient light, noticeable background noise, or other distractions. These impediments may interfere with the user's ability to manipulate the various user interface mechanisms provided for the device: background noise may interfere with the device's ability to detect and correctly process oral commands, and low light conditions or jostling during transit might interfere with the user's ability to accurately input text using a physical or virtual keyboard, or input a gesture command via a touchscreen.

Thus, attention is often focused on improving user experience with improved human interfaces, such as improved physical or virtual keyboards, touchscreens, higher-resolution displays, icon and menu design, voice recognition, natural language processing, haptics, gesture command processing, gaze tracking, and the like. Some of these solutions—such as improved physical interface devices like screens and keyboards, and improved design of screen layouts—can provide a more natural, intuitive, or ergonomic experience for the user, but are directed to the mechanics of the physical human-machine interaction and do not address the problem why some of this physical human-machine interaction is needed in the first place.

Put another way, improvements to the physical human-machine interface can reduce the effort required on the part of the user to issue commands to operate the electronic device 100, but they do not absolve the user of the obligation to issue those commands in the first place. For example, when the user (and the electronic device 100) arrives at a destination after a plane flight, the user might initiate a “search” command to locate the phone number for a taxi service by selecting a search icon on a touchscreen, then inputting the string “taxi” via a physical or virtual keyboard. If the electronic device 100 is configured with assistive location-based technology, such as an on-board GPS module), the electronic device 100 may be configured to determine a current geographic location, and to apply that location as a parameter to the search for “taxi”. The icon and keyboard design—and the assistive location-based technology—may be an improvement over earlier design, but neither eliminates the need for the user to initiate the search command.

Physical human-machine interaction can be improved using other advancements, such as voice recognition and natural language processing; instead of selecting a search function and typing in a text string, the user might instead activate a voice command feature of the electronic device 100 and say “I need a taxi”, in response to which the device 100 could recognize the user's speech, and using a natural language processing module, determine the nature of the command intended by the user (“I need” may be interpreted to mean a local or remote search function), and what parameters should be passed to the module that will execute the command (the search term “taxi”). The electronic device 100, assisted by location-based technology, can thus interpret the statement as a request to search for a taxi service proximate to the electronic device 100's current location, and execute the search. The use of natural language processing improves user experience because physical manipulation of a keyboard is not needed, and indeed in some electronic devices 100 an integrated keyboard (whether physical or virtual) need not be provided at all. Further, the combination with assistive location-based technology, which enables the electronic device 100 to determine a current state of the user and/or device 100 (i.e., the geographical location of the device 100), improves the relevance of the search results.

Improvements to natural language processing and voice recognition can include the use of additional contextual information relevant to the user or electronic device 100 to determine the user's intended commands even when direct instruction is not provided by the user. Contextual information can include observations of user behaviour (i.e., the user's interaction with the electronic device 100, in invoking certain commands or making certain selections) and observations of device state (e.g., the current wireless network signal strength, geographic location, and so on).

For example, the user might be under stress in a busy airport, and might issue a vague spoken command such as “I've got to get out of here”. The natural language processing module, in combination with a location-based sensor module, may determine that “here” is the current geographic location, and that “get out” is relevant to travel; however, it is still ambiguous whether the wants to search for a departing flight, wishes to call a taxi, or needs to find a rental car agency. The electronic device 100, in response, might provide wider-ranging search results that include hits not relevant to the current user's needs. But if the electronic device 100 or the service providing responses to the user's spoken commands is configured to mine additional contextual information, it could be determined, for example, that the email store at the electronic device 100 includes a flight confirmation email for a flight that arrived at the present destination within the past hour, and that the user had never been at this particular airport before (at least, with the electronic device 100) based on a GPS sensor log. These additional contextual clues, together with the user's or electronic device 100's current state (i.e., geographical location) may be interpreted by a natural language processing module or an inference module to determine that the user's command more likely means that she requires a map of the airport or directions to an exit. This example illustrates that in some circumstances, improving the accuracy of natural language processing can involve mining information sources that are not usually assumed to be related either to each other or to the task at hand: in this case, an email store and a location-based sensor history. This example also illustrates that the use of this additional contextual information relieves the user of the need to construct natural language queries according to specific rules (such as the need to specify a particular mode of travel).

Even with the use of these additional contextual clues, it is still necessary for the user to input a command at the electronic device 100, however vague that command might be. However, recognizing that disparate information sources may yield contextual clues for a single user transaction, it is possible to eliminate the need for the user to input the command altogether. In the above example, the user's history of air travel might be manifested in sensor logs or device state logs: during certain periods, wireless network signal is lost, or more tellingly, the electronic device 100 is switched to “airplane mode” in which radio functions are disabled. Further, device application logs may indicate that location technology-enhanced search (for example, using a dedicated search application) is invoked most frequently during periods temporally proximate to the periods when airplane mode is invoked. Coupled with search keywords from those time periods (such as “airport map” or “taxi”), an inference can be drawn that when the device radio(s) are switched back on after a period in airplane mode, a search for local transportation is likely to be invoked. Accordingly, the electronic device 100 could be configured to automatically initiate this search upon a termination of airplane mode.

To implement both the improved natural language processing feature and the automatic initiation of the search described above, a system and method are provided to support the electronic device 100 by correlating context obtained from interdomain information sources—data that is generated as a result of user behaviour or device state in different informational domains that typically do not interact, such as email versus social networking versus location-based services, and the like—in a user or device profile that can then be used to infer or predict a device action or command that will be invoked by the user. This inference may be used to generate an action cue that is provided to the electronic device 100 to invoke that action or command on behalf of the user without the need for either explicit user input to invoke the action (i.e., without requiring the user to input a command at all) or explicit user input of some or all command parameters (e.g., without requiring the user to input a specific command or keyword parameter).

It will be appreciated by those skilled in the art that the example embodiments of this system and method are not intended to be restricted to the natural language processing and search function provided as examples above. The action or command that is determined or enhanced using an inference generated using the interdomain profile described herein may relate to any electronic device 100 function. Another example of a function that may benefit from the use of interdomain contextual clues to infer an appropriate action is prioritization. Examples of prioritization include the filtering or ordering of a message inbox for high priority messages or the automatic selection of a music file for playback when a media player application is launched at the electronic device 100. Still another example of a function that may benefit from inferences derived from the user profile is an autolaunching function on the electronic device 100, which determines when an application 150 should be launched, and automatically launches the application without waiting for an express user command.

Each of these inference tasks may be considered to be a species of a “missing value” problem, in which data obtained from observables—contextual data that might be observed at the electronic device 100, or even at other electronic devices on behalf of other users—is used to infer hidden or missing data. For example, by aggregating contextual data disclosing how users treat messages that are deemed by the users to be “important”, and the characteristics of those messages, it is possible to infer the likelihood that a newly received message will be deemed “important” by the user based on its known characteristics. The missing data, in that case, is the ranking of the message as an important message. A special case of the missing value problem is a “matchmaking” problem, where the best match is found between a first entity (such as a user) and a group of second entities (such as books, music files, other consumer products, or a set of applications available for execution on a device 100) based on observables aggregated to date relating to users' consumer preferences and other behaviour. The method of matching the characteristics of the first entity to a second entity is mediated by other observables or contextual data, such as the current or anticipated state of the user and/or device, such as the current geographic location (as in the search example given above), the current time of day, weather forecast, and so forth.

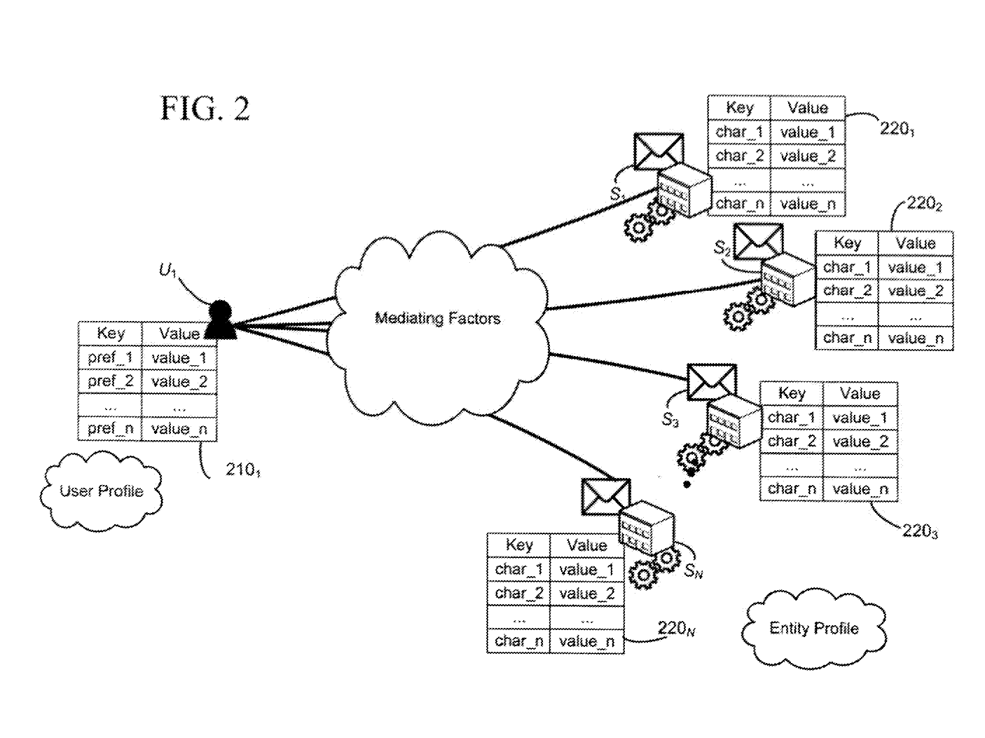

These problems are represented by the schematic of FIG. 2, which demonstrates the correlation between a first entity—the user U₁—and a set of second entities S₁, S₂, S₃, . . . S_{N}, which may be individual emails, applications, or services. The user U₁ may have a number of characteristics represented by the table 210₁. In FIG. 2, these characteristics are represented by a set of key-value pairs for ease of illustration. The values representing these characteristics, however, may be stored in any appropriate form. These characteristics collectively form a profile for the entity, user U₁. Each of the second set of entities is described by a set of characteristics, again represented as a corresponding table of key-value pairs 220₁, 220₂, 220₃ . . . 220_{N}. Again, the key-value pair representation is used only for convenience.

The characteristics of the first entity and set of second entities define the dimensions of the problem of matching the first entity to the best match of the set of second entities. These dimensions may be considered as axes of a coordinate system in an abstract problem space. While the portrayal of entity characteristics as key-value pairs suggests that these entities may be conveniently represented as vectors in the problem space, this is possibly misleading because in practice, the characteristics in sets 210₁ and the various 220ᵢ may not be perfectly known. What may be known, instead, is a probability or “belief” about the entity's correspondence to or compliance with a particular characteristic. Thus, each entity is effectively a probability distribution of compliance with each such characteristic on the problem space within the space of all possible distributions on the problem space, the statistical manifold [symbol] .

As the person skilled in the art will appreciate, formulating the problem in a statistical manifold in this manner permits the expression of probability distributions in [symbol] —and thus the expression of the entities U₁ and Sᵢ—in one of several canonically equivalent ways. A factor graph is one example of a graphical representation of the probability distributions featuring nodes, or factors, each of which represents an arbitrary multivariate function. Factors in the graph are interconnected via one or more variables representing each of the characteristics—in other words, are dependent on one or more variables—and the structure of the graph represents the conditional independence of the variables. A graph may then be constructed merging the probabilistic profiles of the first and second entity or entities to provide a joint probabilistic representation that permits “solution” to find the best match between the first entity and one of the second set of entities, for example by finding the member of the second set of entities with a probability distribution that is the “closest” to the probability distribution of the first entity. This “distance” may be determined using an appropriate criterion, such as the Kullback-Liebler divergence of the first entity's probability distribution and each of the probability distributions of the members of the second set.

The number of possible characteristics that may be incorporated into an entity profile may well be indeterminate, and even infinite in some cases; in examples cited above, the factors relevant to searching extended beyond the immediate apparent scope of the search application and extended to email. Another example is email prioritization, where user profile characteristics are used to determine whether an incoming email should be marked as “important”. The user (first entity) profile characteristics can include user preference factors such as sender identity (those senders whose emails are more likely to be considered high priority), categories (emails considered to be in a work category versus a personal category, for example), content or keywords (emails containing certain strings or keywords may be considered more important), and the like. The characteristics of the second entities, the emails, can include factors such as the sender, category, content or keyword, timestamp, number and size of attachments, whether it is encrypted, and the like. Once a message is categorized as important or not, the user's handling of a message may provide confirmation of the relative importance of an email: messages that the user considers important tend to be read first and replied to more quickly, while messages that are considered unimportant are deleted quickly or deleted without reading.

The correlation of each of the emails to the user profile, however, may be mediated by other factors that are not directly derived from the email or from “typical” user preference factors: for example, the current time/date or the current location of the user may affect the user's assessment of the importance of an incoming message; work-related emails arriving on the weekend may not be as important as personal emails containing content relevant to an imminent event, such as a concert. Emails that might have been considered important when the user was at work may not be considered important when the user is currently located several thousand miles away on vacation. Emails or messages announcing updates to applications installed at the electronic device 100 and inviting the user to download the latest version might not be read or acted upon when the electronic device 100 has low battery reserves, is roaming, or is approaching its monthly data transfer limit, but if the application in question is heavily used, the message might be considered important if the device 100 was docked or connected to a network enabling cost-effective downloading. Further, the user's history in respect of another application, such as a social networking application or content reader, may impact the currently perceived importance of an incoming message. If the user was engaged in reading or participating in social networking posts referencing a specific author (as might be discerned by identifying “trending” topics in the social posts), an incoming email advertising books written by that author might be considered to be important, whereas other advertising email might be categorized as spam.

The confirmation information (the user's handling of a received message) and the mediating factors in these examples arise from contextual information such as the user's behaviour (use of other applications) or the device state, and are conventionally considered to belong to other informational domains that are notionally unrelated to searching, email prioritization, and the like. In view of the number of possible characteristics that might be relevant to a give problem, the dimensions of the problem are therefore indeterminate. Appropriate selection of a subset of characteristics for both the first and second entities—i.e., limitation of the problem dimensions to a computationally practical size—is therefore carried out usefully with the assistance of a domain expert having subject matter knowledge to identify appropriate characteristics to balance the need for a computationally manageable problem, impact of the characteristic on the solution, and availability of data for that characteristic. The creation of a probabilistic description for each of the first and second entities, which involves selection of appropriate characteristics for each entity, will be known to those skilled in the art for the relevant field, whether it is for the purpose of travel recommendations, the identification of important emails, or the recommendation or selection of music appropriate for the user.

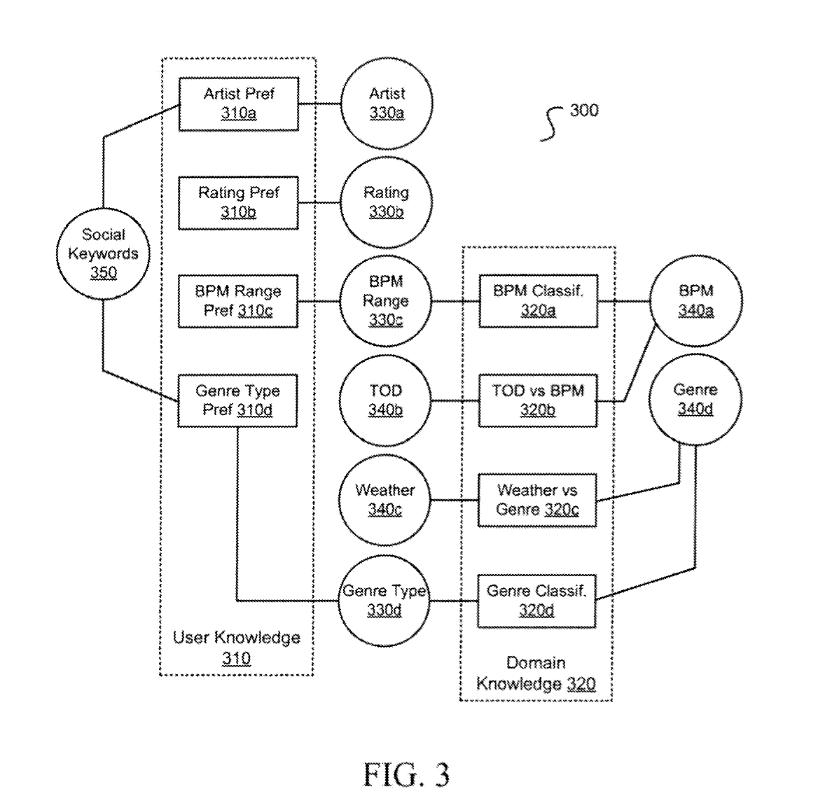

A possible relationship of factors defining a user's profile in an example of music recommendation—identifying a music file in the user's library to be played by a media player on the device 100—is illustrated in FIG. 3. FIG. 3 is a factor graph 300 having a tree structure showing the interconnection of factors (shown as rectangles) connected by edges representing variables (indicated in the circles disposed on the edges). These factors each represent a function—i.e., an arbitrary multivariate function reflecting the degree of probability (or a “belief”) for this given user, which is dependent on the illustrated variables. Each factor is dependent on at least one variable. Thus, for example, the function represented by the factor Genre Type Preference 310d captures the dependence between the first entity's (the user's) social keywords (e.g., keywords or trending topics appearing in social network feeds or posts generated or consumed by the user), Social Keywords variable 350, and preferences for given music genres (Genre Type 330d). As those skilled in the art will appreciate, high or large values in the factor indicate compatibility between the variables, while lower values indicate less compatibility. What constitutes compatibility depends on each individual user, and is encoded in the functional form of the factor, which is adapted to each individual user.

The individual factors may be expressed in a number of ways, including tensors in singleton or matrix form. For example, given a set of possible genre types such as Alt Country, Country, Alternative, Electronic, Indie Rock, New Age, Trance, and Rock, the user's Genre Type Preference factor 310d may be expressed using real values greater than or equal to zero:
[0.3 0.001 0.4 0.8 0.6 0.5 0.7 0.4]

indicating that the user significantly prefers all other genre types over Country. The values need not be limited to expression in this manner, but rather may be expressed using any appropriate scale. During a later stage of computation when determining a recommendation, these values may be normalized as necessary. Some variables and factors are more easily expressed by numeric values, while others may be easier to conceptualize as labels or as Boolean values (true or false).

The Genre Type Preference factor 310d is dependent on two variables, Social Keywords 250 and Genre Type 330d, as indicated by the edges connected to Genre Type Preference 310d. In other words, the function of Genre Type Preference 310d may be expressed f_{GT}(x_{social},x_{genretype}), where the subscripted x variables represent these two variables, respectively. This factor 310d thus has a degree of 2. The factor Rating Preference 310b which might indicate the user's reliance on third-party reviews of music tracks, by contrast, is of first degree, being dependent on the variable Rating 330b alone. The Genre Type Preference 310d and Rating Preference 310b, together with the Artist Preference 310a and BPM (beats per minute) Range Preference 310c, may be considered to be knowledge of preferences specific to the user, and are thus indicated as part of “user knowledge” 310 in FIG. 3. Each of these factors is dependent on at least one variable 330a through 330d and 350, as shown in FIG. 3. Variables are generally objective measurements that can be determined from electronic device contextual data, such as the user's interaction with applications (“application data”) and sensor data (e.g., local time or the user's geographical location as may be determined by a GPS module).

The generation and refinement of the user knowledge factors may be determined from contextual information obtained from the electronic device 100, and in particular from application data—for example, the user's selection of a particular music file for playback may indicate an increased preference for the artist, genre, BPM range of that particular musical work, or the user skipping a particular track during playback of a music album or playlist might indicate a decreased preference for music sharing those characteristics.

Other factors that influence the probabilistic description of the user may not be exclusive to the user alone, but may be common to other users, perhaps derived from direct observations of users as a class, or from experiential information of domain expert. For example, although individual music files may include a numerical identifier of beats per minute, the user's preferences in the BPM Range Preference factor 310c may be expressed according to ranges or descriptors (e.g. “dance”, “rock”, “ballad”; 140-150 BPM, 100-130 BPM, 60-100 BPM), necessitating a conversion of the music file BPM variable 340a according to a classification generally applicable to the entire domain. This conversion is represented by the BPM Classification factor 320a, which as can be seen in the profile 300 is connected to both the BPM variable 340a and BPM Range variable 330c. Similar considerations may be applied to the definition of a music genre; for example, the music file may be identified as “psy” or “eurodance” while the Genre Type Preference factor 310d for the user is expressed in terms of broader-ranging or overlapping categories, such as “trance” or “dance”. Domain knowledge may be applied in the form of a further Genre Classification factor 320d, generally applicable to all users, which effects a conversion between the stated genre of a given music file (the Genre 340d variable) and the format of the input needed for the user knowledge 310 portion of the profile 300. The Genre Classification factor 320d thus defines a domain belief or probability that, for example, psy is considered to fall within the trance category.

Still further examples of domain knowledge applicable to the problem of suggesting suitable music for a given user can include the time of day—for example, experiential data may suggest that upbeat music is preferred in the early morning or late evening, and slower-paced music at midday, as might be reflected by the Time of Day (TOD) vs BPM factor 320b, dependent on both TOD 340b and BPM 340a variables. The TOD vs BPM factor 320b, as a second-degree factor, could be represented as a matrix expressing probabilities that particular BPM values (listed row-wise) are preferred during different times of day (listed column-wise). This particular factor 320b may be dependent on the BPM Range variable 330c instead. Another example of applied domain knowledge is the correlation of current weather to a preferred genre, as indicated by the factor Weather vs Genre 320c; it may be generally found that users, as a class, prefer more sombre music during periods of inclement weather and faster-paced music on sunny days. Other factors, not shown, can even include whether the electronic device 100 is playing back music via integrated or external speakers, or whether headphones are being used, as an audiophile user's choice of music genre may depend on the output method. The detection of connected headphones may be detected by a sensor module 144 at the electronic device 100.

Because the foregoing relationships are likely consistent across most users (and in particular given that these relationships between BPM and time of day, or genre and weather, etc.) were likely derived from observation of a group of users), they are considered to be part of “domain knowledge” 320, as indicated in FIG. 3, although in some example embodiments, the relationship may be highly unique to individuals and therefore may be more properly considered to form part of the user knowledge 310.

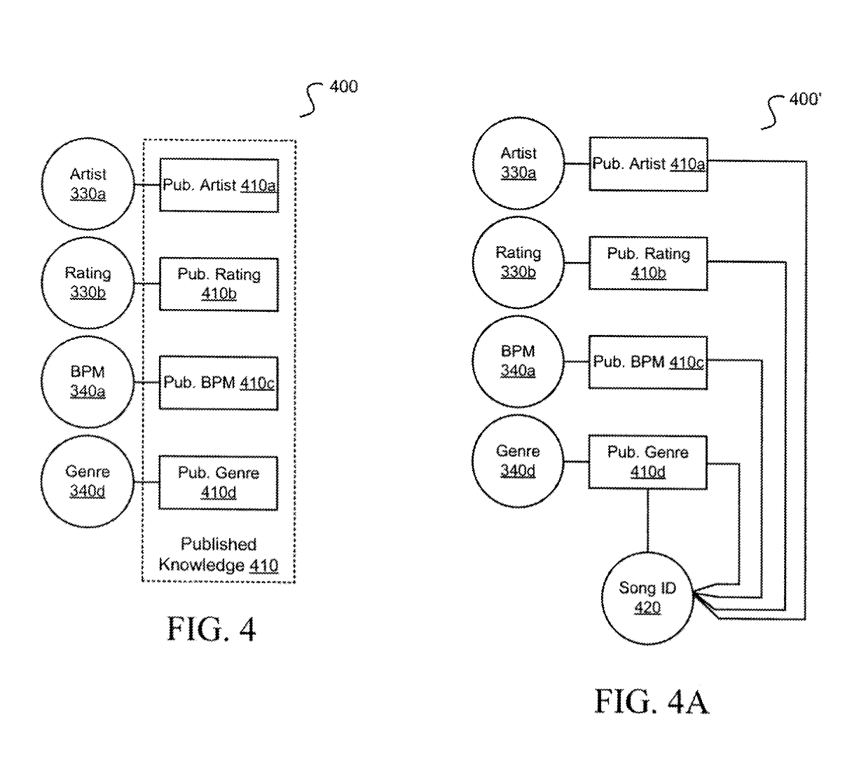

A factor graph representation of the probabilistic description of other entities involved in the problem may also be constructed. FIG. 4 illustrates a simple profile 400 depicting a selected music file, including factors that may be grouped together as “published knowledge” 410, in that the values of the variables upon which these factors are dependent include information that is published (e.g., by the distributor or publisher of the music files), including the identification of the Artist 330a, Rating 330b, BPM 340a, and Genre 340d. In some cases, the corresponding factor Published Artist 410a, Published Rating 410b, Published BPM 410c, and Published Genre 410d dependent on these variables may not be necessary, if the accuracy of the published value is not in question. In some cases, however, the factor might reflect a belief in the accuracy of the published value. For example, the published Rating variable 340b value may be skewed upwards, so the Published Rating factor 410b may reflect a belief in the accuracy of the published rating.

A separate factor graph 300 or 400 may thus be constructed for each member of the first set of entities and the second set of entities, respectively. In the example represented by FIGS. 3 and 4, the factor graph representing the first entity—the user—includes factors determined from both profile information for the user (in FIG. 3, the “user knowledge”) and from domain knowledge. The factor graph representing the second entity, the music file, is determined from publicly available knowledge. In the case where a recommendation or suggestion of a single music file is to be made to a user from hundreds or thousands of available files, there would be only one user factor graph 300, but hundreds or thousands of music file factor graphs 400 that would need to be solved in order to determine which of the music files were the best matches for the user. This determination can be made by measuring the “distance” between the user's probability distribution and each of the music file probability distributions. The music file probability distribution resulting in the smallest “distance” from the probability distribution of the user in the relevant manifold or sub-manifold is the best match.

As the person of ordinary skill in the art would appreciate, the distance between probability distributions may be approximated by solving the problem

$$\hat{i} = arg {min}_{i = 1 , 2 , … N} H ( {pq}_{i} ) \qquad ( 1 )$$

where p is the probability distribution of the first entity (user) U₁, qᵢ is the probability distribution of the ith second entity (e.g., music file), and H(·) is the information theoretic entropy of a probability distribution (i.e., the measure of uncertainty associated with the unknown information of the problem). This approximation is derived from the Kullback-Leibler divergence, which may be used as a measure of distance between the distributions and provides a reasonable criterion for matching the first entity with the best second entity, but recognizing that to a first order this divergence is approximated and symmetrized by the Riemmanian metric derived from the Fisher information of the problem. Use of equation (1) thus suggests that the appropriate second entity is the one that minimizes the uncertainty when simultaneously considering the probability distributions of both the second and first entity; i.e., where p and qᵢ are best matched to each other, meaning that the product pqᵢ is a highly peaky probability distribution.

Equation (1) involves a pointwise multiplication of rᵢ=pqᵢ, meaning that in a factor graph representation of rᵢ, the factors of p and of qᵢ are simultaneously present. Accordingly, the graphical models of the joint factor graph rᵢ for i=1 . . . N could be easily constructed. It would then be necessary to compute the entropy H(rᵢ) for each to identify the rᵢ yielding the smallest entropy.

While the computation of the entropy of rᵢ may be within the knowledge of those skilled in the art, it is computationally complex, and the complexity increases exponentially with d, the number of dimensions of the problem. Calculating entropy for each possible joint factor graph rᵢ therefore incurs a significant amount of processing and/or memory resources. The problem's complexity may be reduced by calculating instead an approximation of the entropy for each rᵢ based on the entropies of its marginal distributions, where the marginal distributions are approximated using a message passing approximation technique such as the sum-product algorithm, which has complexity O(d). When the factor graph rᵢ is tree-like and not cyclical, the exact entropy of the marginal distributions can be calculated, so the approximated entropy of rᵢ will be the true entropy. Use of the sum-product algorithm to compute marginal distributions, and its programmatic implementation, as well as the programmatic representation of factor graphs, will be known to those skilled in the art. Details concerning the use of the sum-product algorithm are described, for example, in Kschischang, F. R., and Frey, B. J. and Loeliger, H., “Factor Graphs and the Sum-Product Algorithm”, IEEE Trans. on Information Theory, February 2001, vol. 47, No. 2, pp. 498-519.

Even so, with complexity O(d) the sum-product algorithm must still be run independently on each factor graph N times (since i takes values 1 . . . N, one for each second entity). The number of second entities N may be quite large, particularly when the method is run for all possible matches (e.g., of music files in a library accessible to the electronic device 100) without limitation. It may also be large in cases where the method is used to make recommendations from a pool of second entities beyond the electronic device 100 (e.g., music files available for purchase from an online vendor, versus those currently stored at the device 100) or to prioritize individual data items in a data store, such as emails. Again, solving this problem likely would consume a significant amount of processor and memory overhead.

Accordingly, to further reduce the computational burden and complexity in solving the problem of identifying the best matches for the first entity, a new factor graph is constructed to jointly represent all second entities. To construct this new factor graph, it is presumed that a generic factor graph structure can be used to represent the probability distribution for each member of a set of entities, although the values of the individual factors in the factor graph structure may vary for each member. Thus, given a generic factor graph for a single member of the second set of entities qᵢ, an extra identifying variable is added to represent the name or identity of the second entity. This new variable can be expressed in vector form, where each value in the vector corresponds to and takes a value from one of the set of second entities (i.e., the set of music files).

Adding this extra variable to the factor graph uplifts every factor in the existing graph 400 by one dimension. Thus, where a factor in qᵢ was previously a vector, it will be uplifted to a two-dimensional matrix, and will be dependent on one additional variable. An example is illustrated in FIG. 4A where the additional variable Song ID 420 has been added, and is connected to each of the previously existing factors in a new factor graph 400′. Each of the existing factors 410a . . . d, and any other factors in the factor graph, are thus dependent not only on their previous corresponding variables, but also on Song ID variable 420. The uplifted factors that were previously vectors are now simply row-wise stackings of the probability distributions of all individual music files in this media player example. FIG. 4A thus represents the entire second set of entities (music files).

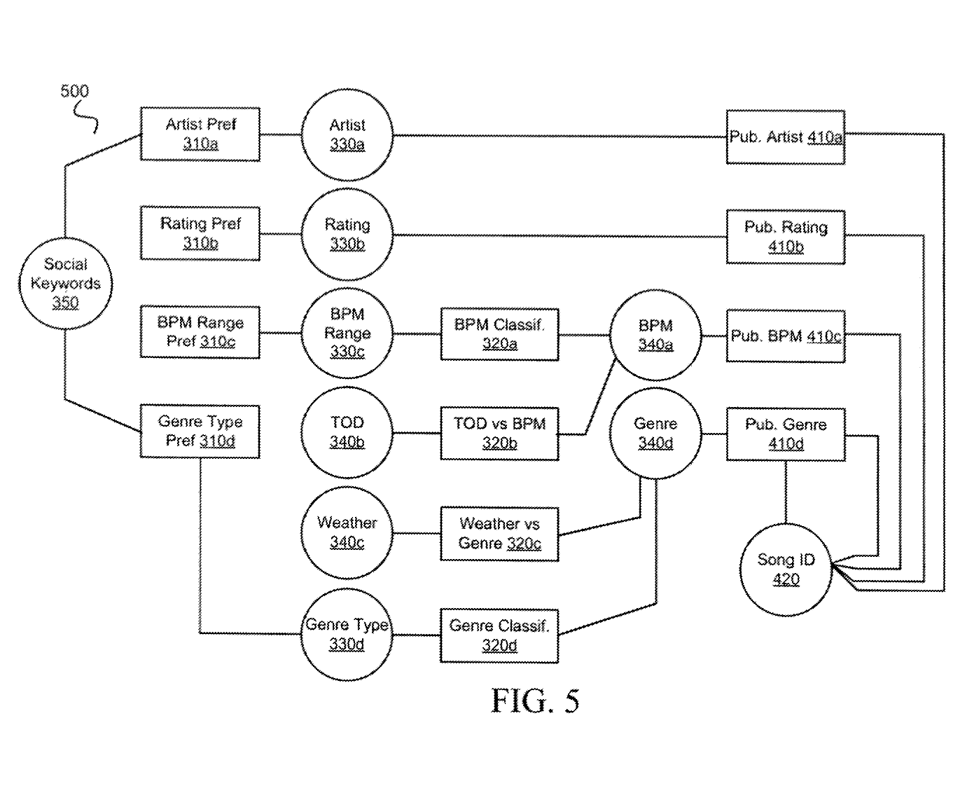

To solve the matchmaking problem, the factor graph representing the second set of entities is merged with the factor graph 300 representing the first entity, yielding a merged factor graph, shown as 500 in FIG. 5. It can be seen in this example that the merger reflects the common dependencies on three variables that existed in the user's factor graph 300 and in the factor graph 400′ representing all music files: BPM 340a, Genre 340d, Artist 330a, and Rating 330b. To provide a merged factor graph, it is not necessary that the two independent graphs (i.e., the first entity profile factor graph 300 and the second entities' profile factor graph 400′) be dependent on a plurality of common variables. The two factor graphs may have only one variable in common, such as Genre 340d.

Because of the aforementioned uplifting of one of the variables, rather than solving for the marginal probabilities of each individual factor graph for each individual service provider, it is now possible to simply solve the merged factor graph 500 for an a posteriori probability mass function of the Song ID variable 420, given a value for at least one variable represented by the merged factor graph 500 again using an appropriate technique such as the sum-product algorithm. The given value may be contextual data received from the device 100, such as device state data or sensor data (a state indicating that headphones are plugged in, as mentioned above, or sensor information such as the current time of day at the geographic location of the device 100). The given value may be provided to the system solving the merged factor graph 500 in a request, and the second entity identified in a solution of the factor graph 500 can then be provided to the electronic device 100 in a response. The given value need not be provided directly from the device; for example, contextual data such as local weather could be determined by the system solving the factor graph 500, given the geographic location of the electronic device 100.

The person skilled in the art will appreciate that it is no longer necessary to compute an approximate entropy for the new merged factor graph. Instead, it is simply necessary to read out the converged belief vector (since as mentioned above the variable 420 may be represented by a vector) on the variable for the name of the second entity, which defines the probability mass function of the variable; that vector will contain the answer to the problem. The resultant vector will include a set of values corresponding to the set of second entities (i.e., music files) represented by the factor graph 500, and each value will represent a probability or a posteriori belief for the corresponding one of the second entities, based on the a priori beliefs represented in the factor graph 500. The second entity corresponding to the greatest value in the solved variable 420 will therefore be the best match or the best recommendation based on the other information represented in the factor graph 500.

In other words, since the factor graph 500 can now be solved (using a message passing algorithm, for example) for the vector representing the Song ID, it is not necessary to compute the entropy for each individual second entity before identifying the one second entity that is the best match for the first entity. Obtaining a vector of probability values for the Song ID variable 420 is sufficient. The values in the vector variable obtained by solving the factor graph 500 reflect the product of the user profile factors and a given set of music file factors; if many factors provide low values, then the product will also have relatively low value, thus indicating a low match (or less compatibility) between the user and that particular song. However, when many of the factors provide a high value, the product of the factors will also be high, indicating a good match between the user and the song. It will be appreciated by those skilled in the art that this solution, which can be implemented in software using known numerical and other computation techniques, requires significantly less computational power and memory than the above-mentioned prior solution method.

The definition of the factor graphs 300, 400, 500 and the solution for the Song ID variable 420 (or for whatever identifier variable is employed in the merged factor graph 500) may be carried out at the electronic device 100, or at another electronic device such as a server or other computing device in communication with the electronic device 100. Thus, for example, a number of electronic devices 100 may request results from the server for cues to be applied to actions executable at the devices 100, such as identifying a media file to be played back at the device 100 by a media player; identifying a received message as an important message, to be marked as such by a messaging application; identifying search terms or other parameters to be used in executing a search by a search application; and, generally, receiving parameters to be applied to execution of a user-initiated command. An example of a user-initiable command includes the above-described search command; another example is the use of spoken commands, requiring natural language processing and voice recognition functions. A factor graph may be constructed and solved to correlate words detected in the spoken command to meaningful parameters to be used by an application in executing in instruction. Some of the factors and variables may be derived from application data generated by an application that is different from the application receiving the cue and executing the action based on the recommendation or response from the server, thus incorporating interdomain intelligence into the solution.

The decision to include the various factors, and determining the dependencies of each function or factor on variables—i.e., the construction of the overall factor graph 300—may have a theoretical basis, for example based on a domain or subject matter expert's knowledge about the influence these variables have on user behaviour or preferences. The factor graph 300 may also be constructed based on observed relationships or dependencies between these variables and user behaviour or preferences, as may be determined from contextual information obtained from the electronic device 100. However, construction of a sufficiently complete probabilistic description of a given user, and the ability to recognize that some factors are even relevant to the user profile—such as the ability to recognize that social keywords or trending topics (as indicated by the Social Keywords variable 350) is relevant to a user's Artist Preference factor, indicating a belief in the user's level of dependence on popular opinion of her social networking friends—may require additional insight that a user's other messaging or social networking habits are relevant to music preferences. Thus, the construction of the user profile 300 in factor graph form (or indeed, in other forms) generally requires the application of knowledge in the tasks of identifying and selecting the particular factors to be included in the factor graph; deciding the optimal connectivity of the factors by variables.

The design of the factor graphs of FIGS. 3 to 5 may be accomplished manually, using, as noted above, the knowledge of a domain expert. However, the scope of possibly relevant information that is outside the usual information domains for a given problem, and the number of factors and/or variables required to construct the factor graph, increases the complexity of these tasks. Determining the connectivity of the possible factors can be a difficult combinatorial problem.

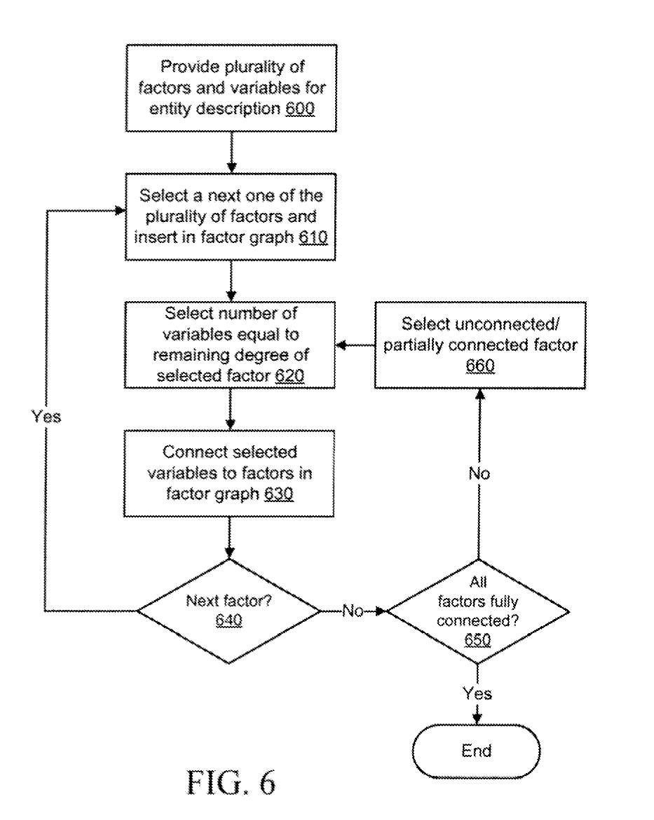

It has been discovered, however, that random coding theory may be applied in the construction of factor graphs representing the first and second entities' probabilistic distributions, thus avoiding the necessity of predetermining a factor graph structure according to set rules (such as the dependence of a particular factor on a particular variable). Given a selection of factors of varying degree and a number of available variables, the factor graph may be constructed as depicted in the flowchart of FIG. 6. First, at 600, a number of factors and one or more corresponding variables for use in defining the probabilistic description of the subject entity or entities are provided. These factors and variables may be stored in a profile store such as that described below. Generally speaking, it is expected that the plurality of factors will have a soliton-like distribution, where factors have a higher probability of having a low-order degree (e.g., 2 or 3), and a lower probability of having a higher degree. This may be particularly the case in the interdomain examples described above, where a number of factors defining “one-off” relationships between two disparate variables may be defined. For example, a relationship between weather and music genre was identified in the example of FIG. 3, as represented by the Weather vs Genre factor 320c; in another domain, such as travel-related searches, weather may be relevant to the user's preferences when looking for directions to a local destination; in inclement weather directions to the nearest taxi stand may be preferred to public transit directions, which may result in the definition of a factor correlating weather and mode of transport. While these two factors are both dependent in part on a weather variable and both may be selected for inclusion in the method of FIG. 6, both are only second degree factors.

Next, at 610, one of the plurality of provided factors is selected and inserted or added into the factor graph. The factor may be selected at random. While “insertion” or “adding” suggests a physical addition of a factor into a pre-existing graph, it will be understood by those skilled in the art that programmatic or mathematical representations of factor graphs are contemplated herein, and that the “insertion” or “addition” may include the definition of a representation of the factor in memory. The factor added at 610 will have a degree d (e.g., in the case of a two-dimensional matrix, the factor will be of degree 2). A number of variables equal to d is selected from the plurality of variables at 610. Preference may be given to those variables in the plurality of variables that are not currently connected to any factor; if no such variables remain in the plurality of variables, then one of those variables having the lowest number of connections is selected (e.g., a variable connected to only one factor is selected ahead of a variable already connected to two factors). Aside from this preference, the selected variables may be chosen at random from the pool of variables. These selected variables are then connected to one or more factors currently inserted in the factor graph at 630.

The steps 610 to 630 are then repeated until the factor graph is fully connected. At 640, it is determined whether there remains another factor to be added to the factor graph. If there remains another factor, the method returns to 610. Otherwise, if there are no further factors to be added and all factors are fully connected according to their degree as determined at 650, then the method ends. If factors remain not fully connected, then at 660 one of the unconnected or partially connected factors is selected, and the method returns to 620 to connect that unconnected factor to an appropriate variable. The same method may be applied not only to the first entity (user) factor graph, but also to the factor graphs of other entities, and indeed rather than construct two separate factor graphs and merging the two as described in relation to FIGS. 3 to 5, a single factor graph may be defined incorporating all the factors identified in FIG. 5 without first defining separate factor graphs and determining how to merge the two.

Thus, the construction of the factor graph is effectively random, subject to the constraint that the number of connections in the factor graph is equivalent to the total number of degrees of freedom of the various factors in the graph. Because a random construction is used, a domain expert is not required to construct the factor graph and determine the connectivity of the various factors, thus providing a more efficient means of constructing the factor graph. The end result is that a factor graph constructed from the same factors as that shown in FIG. 3 may not, following the method of FIG. 6, match the depicted structure of the factor graph 300. As those skilled in the art may appreciate from coding theory, random graphs can yield good, capacity-achieving channel codes. It is therefore expected that since machine learning problems of the type described above are analogous to easily decodable codes, a randomly-chosen connectivity pattern according to the method described above will likely yield factor graph design that is sufficiently close to optimal to provide suitable results. Since the factor graph may be generated with a random structure, there is no requirement to store the interrelationships between specific factors associated with a given user, or to specifically store a particular factor graph construct in association with a given user; the factor graph is instead stored in a modular form (i.e., as separate factors) and can be constructed on an ad hoc basis by retrieving any group of factors from a data store, then connecting the factors with variables at that time.

Indeed, because

dependence on domain experts to provide even the domain knowledge portions of a factor graph may no longer be required.

It will also be appreciated by those skilled in the art that the trivial case of a factor graph, with only one factor and one variable, is contemplated in the example embodiments described herein. Of course, such a simple factor graph does not require an elaborate method for construction, as there is only one variable to be connected to one factor.

Thus, once various factors—including interdomain factors—are defined at the server or the other electronic device defining the factor graphs, these same factors may be repurposed to generate factor graphs directed to other problems. Moreover, factors that were defined to solve a problem for one user may be ported to a problem defined for a different user, and refinements to factors based on one user's contextual data may be used to benefit other users, since the refined factor can then be used in other factor graphs generated for other problems and users. The factor graph construction and solution methods provided above thus not only facilitate the use of interdomain intelligence, but also inter-user intelligence as well.

As explained above, the development and solution of useful factor graphs and probabilistic descriptions of entities rely on the gathering of contextual data generated by or on behalf of the user or electronic device 100. This contextual data is then relayed to the system used to develop the factor graph, where it is processed accordingly (for example, as described above) to generate cues for actions to be carried out at the electronic device 100. In exchange for the raw data provided to the system, the electronic device 100 receives cues and other data that can be used to enhance user interaction.

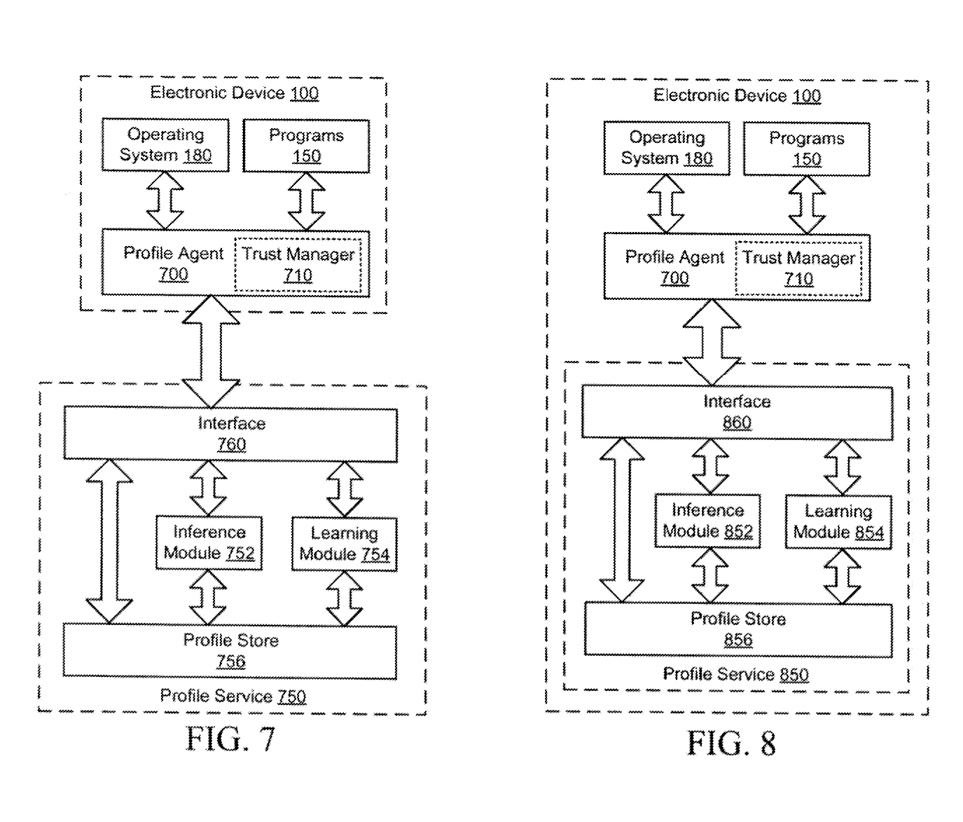

The collection of contextual data for use in producing and solving factor graphs is described in greater detail in the following drawings. Turning to FIGS. 7 and 8, example schematics for implementing such a solution with an electronic device 100 are shown. In the example embodiment of FIG. 7, a profile service 750 including an inference engine and associated services is provided at a location remote from the device 100, accessible by the device 100 over a network connection (fixed or wireless). The electronic device 100 includes (as illustrated in FIG. 1) operating system 140 and program 150 modules, which interface with a component or module executing on the device and providing an interface with the profile service 750, here illustrated as profile agent 700. The profile agent 700 may interface directly with the various operating system 140 modules, or with the individual programs 150 executing on the device 100 and/or their corresponding data stores (not shown), or with both the operating system 140 modules and individual programs 150 and/or data stores. In some examples, such as that illustrated in FIG. 10 described below, the profile agent 700 interacts only with the operating system 140 modules on the electronic device 100 for the purpose of collecting context information, and not directly with the individual programs 150. In other example embodiments, particularly when an individual application executing on the device requires an action cue as described below, the individual application may interact directly with the profile agent 700.

The profile agent 700 interoperates with one or more of the foregoing components to collect context data generated by context-generating components of the electronic device 100, such as sensor modules 144, device state modules 142, other operating system 140 modules, and individual applications 150, for use in updating a user or device profile. The profile agent 700 also functions as an interface or proxy with the profile service 750, providing to the profile service 750 notifications or updates for the user or device profile, based on the collected context data, and providing to the operating system 140 modules and/or applications 150 action cues received from the profile service 750 in response to module/application requests. Access to the profile agent by individual operating system 140 components or applications 150 may be provided through an API (application programming interface) or using other suitable programmatic interfaces.

The context data collected by the profile agent 700 may vary according to the various types of applications 150 and operating system 140 modules implemented at the electronic device 100. For example, context data may include, for search applications executing at the device, search parameters such as keywords; resources or databases searched; and times of day of searches. Context data for a sensor module 144 monitoring geographical location (such as a GPS module) can include geographic coordinates and corresponding time of day; the sensor module 144 may, for example, generate a log including periodic GPS coordinate readings while the GPS module is activated. Context data for another sensor module, such as the optional accelerometer or orientation module 111, can include detected orientation and corresponding time of day (again, the sensor module may generate a log with periodic readings) or detected orientation and an identifier of the application currently active at the electronic device 100, although a log of which applications were executing at the device 100, and which constituted the active screen displayed at the device at a given time, may be generated separately by the device state module 142 or by another operating system 140 component. Other sensor or device state data recorded at the device can include ambient light levels; wireless signal strength; wireless network identifier; whether wireless data service is enabled or disabled; magnetic sensor or proximity sensor data (reflecting when the electronic device 100 is in an “in-holster” state, covered with a smart cover, or in the case of a smartphone or cellphone, held near a user's head during a phone call); screen brightness; speaker volume; use of the microphone for receiving spoken commands; data transfer levels (i.e. the amount of data uploaded or downloaded from or to the device 100 within a specified period of time); when the electronic device 100 is docked or charging; battery level; when headphones are plugged in or when the speakerphone function is in use; times of connections of other devices, and their identities, via Bluetooth, Wi-Fi, or near-field communication protocols; and the like. The foregoing sensor or device state data thus provides context regarding the state of the user and/or electronic device 100, and is typically recorded in association with a time index or value, or some other index value that permits this contextual data to be correlated with other types of contextual data.

Application data logged by the profile agent 700 can include search parameters, as mentioned above; address book contact data; social networking application 157 or messaging application data such as the identities or userids of other users with whom the user of the electronic device 100 corresponds; userids of social networking “friends”; keywords located in messages or social feed posts; URLs of webpages visited using the browser application 155; weather forecast or current temperature data, and corresponding dates or times, received by a weather application 158; applications downloaded and installed using the app store app 159; URLs or other source identifiers for content feeds read using the reader application 154; recipients and senders of messages sent or received using a messaging application 151, 152; the handling of messages (e.g., when they are read, replied to, deleted); subject lines, timestamps, and other characteristics of messages; subject lines and attendees of calendar events; whether reminders for calendar events are dismissed, and when; and identification of music files or other media files selected for playback using the media player 156, and/or their properties such as genre, length of playback, and so forth. Indeed, any function or feature used on the electronic device 100 may be the subject of context data collected by the profile agent 700 for use in developing a user or device profile, and the foregoing data types are merely a partial list of the possible types of context data that may be collected. Again, many of these types of contextual data will be recorded in association with timestamps or other index values so that the data can be correlated with other contextual data.

Context data may be provided to the profile agent 700 in log form—for example, the profile agent 700 may retrieve logs generated by each individual application or module and stored at the electronic device 100—or else the profile agent may register as a listener with each relevant application 150 and/or corresponding data store and operating system 140 module to receive notifications of events (such as orientation change detection or queuing of an outbound message for transmission).

The profile service 750 is implemented by one or more electronic devices such as servers, and includes an interface component 760, for providing access to the profile store 756 and to functions provided by the inference module or engine 752 and the learning module or engine 754. Access to the profile service 750 functions by the profile agent 700 may be provided by way of a web API or another web service interface supporting REpresentational State Transfer-based communications, although other non-RESTful web service architectures such as service-oriented architectures and remote procedure call web services may be implemented instead. In some example embodiments, the profile agent 700 provides its collected context information to the profile store 756 by means of this interface on a periodic or ad hoc basis, for example via a wireless network connection; in other example embodiments, the collected context data is uploaded to the profile service 750 in batches, optionally when a fixed connection is available. For example, the profile agent 700 may be configured to upload context data when the electronic device 100 is docked for charging. While waiting for the device to be docked or for another event to trigger the uploading of context data creates latency in the updating of the profile managed by the profile service 750, this latency may be negligible since the collected data, as explained below, is generally used to update or refine an existing profile.

It will be appreciated by those skilled in the art that while the amount of context data collected by the profile agent 700 may be voluminous, much of the data may be redundant (particularly sensor data) and easily compressed for transmission to the profile service 750. Further, as explained below, at least some application data need not be transmitted from the electronic device 100 to the profile service 750 at all; message data, for example, is frequently stored or mirrored at a network data store, so the message context data may be provided by the network data store over a network to the profile service 750, bypassing the electronic device 100. Similarly, content feed reader and browser data may be cached at a networked server that may be configured to provide context data to the profile service 750.

To protect user contextual data, the data may be encrypted by the profile agent 700 or by another encryption module at the electronic device 100 prior to transmission to the service 750. Further, the collected data and the user profile developed using the data may also be stored in encrypted form. When the electronic device 100 and/or user is initially provisioned with the profile service 750, a key may be defined and provided to the electronic device 100 for use in encrypting data, but not maintained at the profile service 750. Subsequent requests to the profile service 700 for action cues may then be accompanied by the key for use by the service in decrypting the user's data. Various mechanisms for safeguarding the encryption key in transit, and other means of securing the user's data at the profile service 750 so as to restrict access only to authorized users and devices 100, will be known to those skilled in the art. Of course, if the profile service 850 is implemented on the device 100, concerns regarding bandwidth consumption in transmitting contextual data back to the service are alleviated, as well as any concerns regarding maintaining user privacy or security over the data.

As shown in FIG. 7, each of the modules 752, 754 interacts with a profile store 756 where profile data for individual users and/or electronic devices 100 is stored. For ease of reference, the description below will refer generally to user profiles rather than device profiles; however, given that an individual user can be associated with a single electronic device 100 (although not necessarily exclusively), it will be appreciated that profile associated with a “user” and a profile associated with a particular “device” or “electronic device” may be considered to be interchangeable unless otherwise specified. In some example embodiments, though, a profile specifically associated with an electronic device is appropriately considered to be associated exclusively with a given electronic device 100 rather than with the device's designated user; and a user profile is more appropriately considered to be associated exclusively with a given user, regardless what electronic device the user is currently using. It will be appreciated by those skilled in the art that a profile that is associated with a specific user, rather than with a specific electronic device 100, may be treated as “portable” by the user, and can continue to be associated with the user even when the user changes to a different electronic device 100.

In an alternative example embodiment, shown in FIG. 8, the profile service 850 is resident on the electronic device 100 itself The electronic device 100 in this example embodiment has sufficient computing power to implement the inference module 852 and learning module 854 to generate and update a profile in the profile store 856, and to respond to queries from operating system 140 components and individual applications 150 via the interface 760. In this example embodiment, the interface 760 for the profile service 850 may be an API or any other appropriate programmatic interface mechanism. Otherwise, the various components can interact with each other generally as described above with reference to FIG. 7.

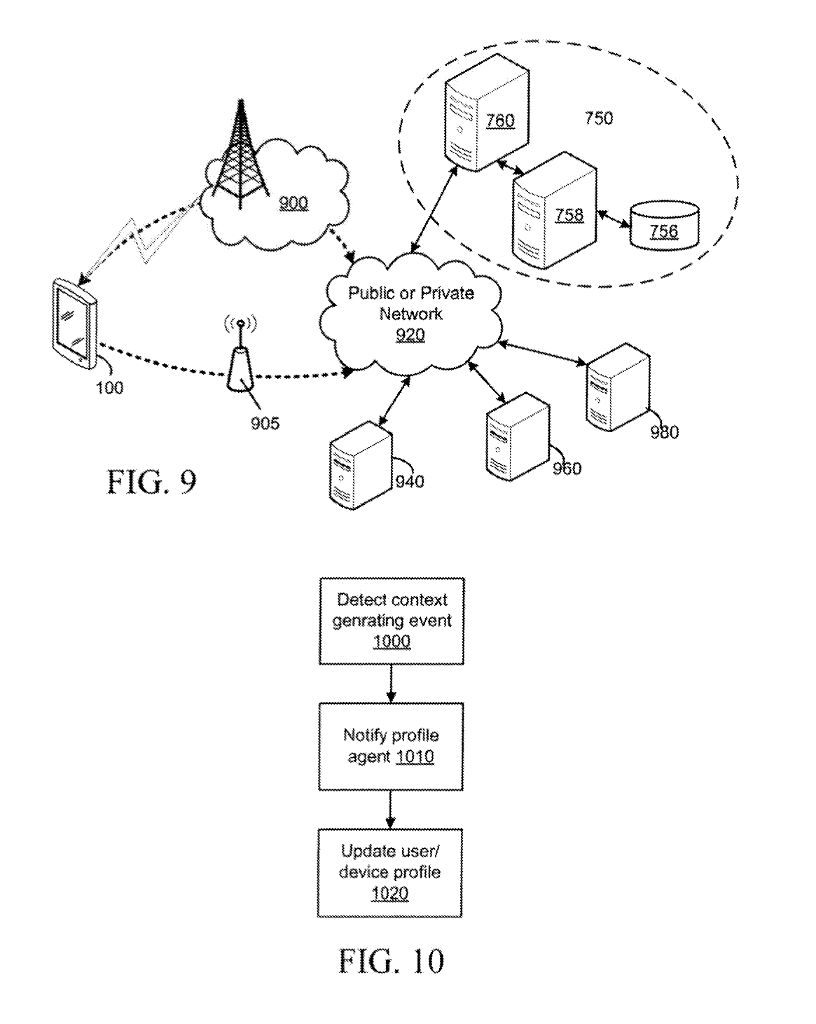

FIG. 9 illustrates an example network for use with the electronic device 100 and profile service 750, and, effectively, an alternative view of the schematic arrangement of FIG. 7. It will be understood by those skilled in the art that the accompanying figures provide simplified schematics of the service 750 and simplified network topologies, omitting a number of components such as peripheral devices, routers, mobile data servers, and the like for ease of exposition in the accompanying figures. Further, it will be understood that the networks illustrated herein may include different components and/or be arranged in different topologies than that shown in the accompanying drawings.

The electronic device 100, here represented by a mobile device such as a smartphone or a tablet computer, is adapted to communicate over a fixed or wireless link with one or more network resources. In the example of FIG. 9, communications can take place over a public or private network 920 such as the Internet. Further, in the example of FIG. 9, wireless communication with the network 920 is illustrated with paths for both data and voice traffic, for use where the electronic device 100 is provisioned for voice communication, although the electronic device 100 may certainly access the network 920 over a fixed connection.

The electronic device 100's access to IP networks and to a public switched telephone network (PSTN), if applicable, can be provided through the wireless network 900, which includes one or more nodes configured for communication in accordance with a suitable mobile telephony standard. In turn, the wireless network 900 provides the electronic device 100 with connectivity to the Internet or other public wide area network 920, and thence to one or more services and systems. Alternatively, the electronic device 100 may access the network 920 without using the wireless network 900. Instead, the electronic device 100 may gain access to the network 920 via an access point or at a public or private Wi-Fi hotspot, represented by the access point 905.

Services 940, 960, 980, implemented in electronic devices such as servers, accessible over the network 920 can include one or more types of web-based services, such as a web server, messaging service, social network service, push service, online commerce (e-commerce) service, content service (e.g., newsreader or content aggregating services), directory services, collaborative applications, calendar applications, files servers, search engines, and the like. These services may be accessible using the browser application 156 on the electronic device 100, or using other applications 150, including applets, widgets and the like that may operate in a browser environment or in a different runtime environment. These applications and other modules used to access these services would therefore be configured to issue requests and to receive responses over the network 920 via the electronic device 100's communication subsystems. In particular, one of these services is the profile service 750, which is illustrated in FIG. 9 as including a web server 760, a prediction or inference server (hosting the inference module 752 and machine learning module 754), and profile store 756. These components may be integrated in a single server or across multiple computing devices. The profile service 750 may be provided as a standalone service, as shown here, or may be incorporated into another online service 940, 960, 980.

FIG. 10 provides an overview of the context-collecting phase of the development of an interdomain user profile. At 1000, a context-generating event is detected. This event may be an event detected by a sensor module 144 or device state module 142 (a loss of wireless signal, invocation of airplane mode, a GPS reading), or an event detected or generated by an application 150 (transmission or receipt of a message, obtaining weather forecast data, invocation of a search command, playing a music file, and the like). At 1010, the profile agent 700 is notified of the detected event. At 1020, the profile agent 700 transmits contextual data derived from the detected event to the profile service 750 in association with a user identifier, and the user profile is updated at the profile service 750.

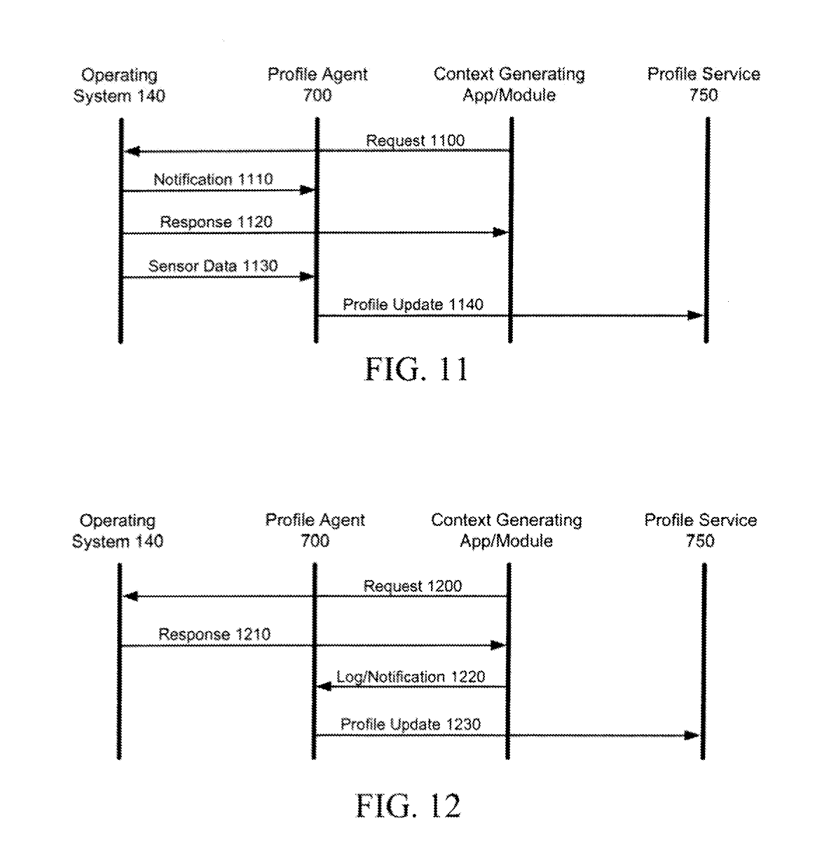

This is illustrated in FIG. 11, which shows the interaction of the various components of the electronic device (the operating system 140, profile agent 700, and context generating application or module). Contextual data relating to user actions, such as actual use of applications 150 executing on the device 100, may be gathered when the executing application or module at the electronic device 100 transmits a request 1100 to an operating system interface. This request 1100 may be a request generated in response to a user command, for example to access a data file, save a data file, initiate transmission of data, and so forth. In the example of FIG. 11, the operating system 140 provides a notification 1110 to the profile agent 700 of the context-generating event invoked by the application or module. The notification includes an identifier of the application or module making the request 1100, as well as data concerning the request (e.g., search parameters, an identifier of a file accessed or saved by the context generating application or module, et cetera). The operating system 140 also provides whatever response 1120 to the application/module's request 1100 is appropriate. The order of the notification 1110 and the response 1120 may be switched; the notification 1110 need not precede the response 1120, and to maximize responsiveness to user commands, the notification 1110 would likely be issued after the response 1120.

In addition, sensor data 1130 generated by the operating system 140 (or, more specifically, by a sensor module 144) is provided to the profile agent 700. The sensor data 1130 may be in the form of a notification issued by the sensor module 144 and received by the profile agent 700, although as noted above, the profile agent 700 may instead retrieve logs generated by the sensor modules 144. Finally, the profile agent 700 communicates the contextual data derived from the data generated by the applications 150 and sensor modules 144 to the profile service 750 as a profile update 1140. The profile update 1140 may be transmitted asynchronously; transmission of a profile update 1140 need not be triggered by receipt of a notification from the operating system 140, but may be carried out on a period basis with any contextual data collected in the meantime by the profile agent 700.

In one example variation, the context generating application or module notifies the profile agent 700 directly of the context-generating event, as shown in FIG. 12. The context generating application or module transmits a request 1200 to the operating system 140, and the operating system 140 provides an appropriate response 1210. The context-generating application or module then provides relevant contextual data 1220 to the profile agent 700, either by way of a log made available to the profile agent 700, or by issuing a notification for the profile agent 700. Again, the profile agent 700 transmits a profile update 1230 (which may include contextual information derived from sensor data) to the profile service 750.

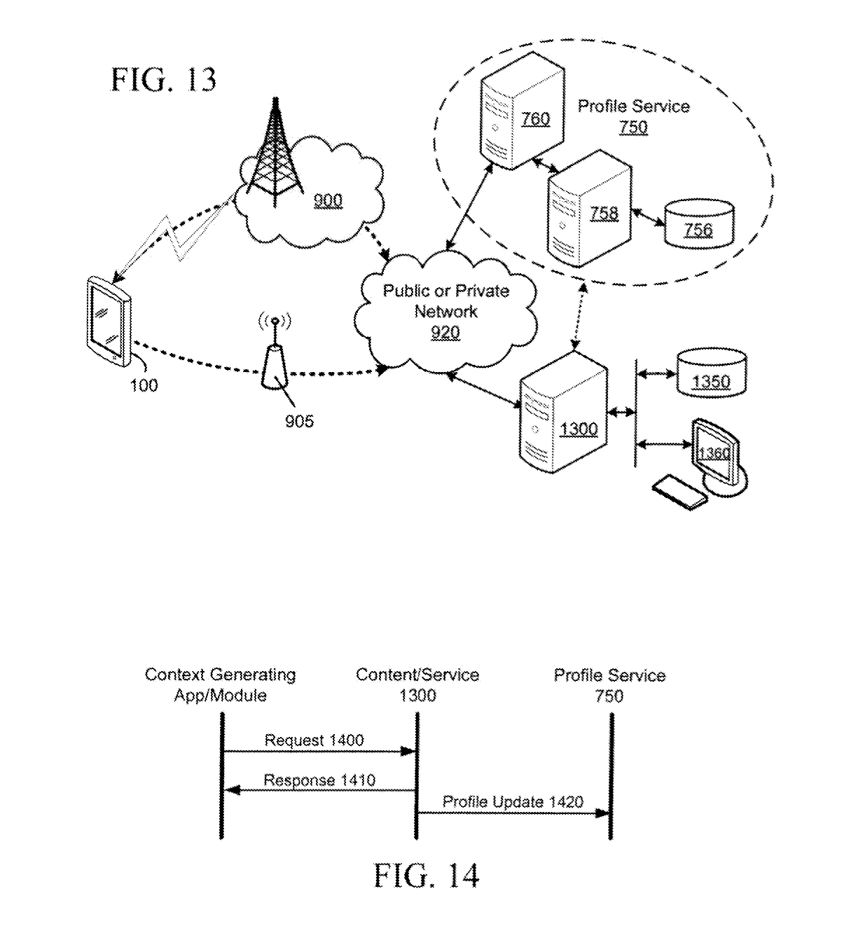

As mentioned above, some contextual data can be obtained from a network-based (or “cloud”-based) service, since some application data is typically stored in a networked repository. The network topology shown in FIG. 13 is similar to the topology shown in FIG. 9, with the electronic device 100 accessing the profile service 750 via a public or private network 920. In some cases, the electronic device 100 may be registered with an organizational domain provided in a host system, which can be an own-premises local area network (LAN), or wide area network in communication with LANs, with local computing resources such as one or more servers 1300 and one or more data repositories 1350. The LAN may include client devices 1360 such as terminals or workstations, or alternatively these client devices 1360 may, like the electronic device 100, access the one or more servers 800 over a wide-area network, such as the public or private network 920. The servers 1350 and data repositories 1355 may represent controllers, security and information technology policy modules, application servers, messaging servers, file servers, databases, memory devices and the like for providing services its registered users. The services can include but are not limited to messaging, directory services, collaborative applications, calendaring applications, search engines and file servers.

These services can be provided in a self-hosted system as suggested above, i.e., a host system supplied by and managed by the organization. However, the person skilled in the art will appreciate that one or more services may instead be provided by third parties directly to the user of the electronic device 100, or for the user as part of the organizational domain in a software as a service, platform as a service, or infrastructure as a service arrangement, colloquially referred to as cloud computing services. For example, email messaging services or collaborative applications can be hosted by a third party service maintaining an external server 1300 and data repository 1350. However the system is implemented or organized, contextual data may be retrieved from the server and/or data repository 1350 and communicated, either directly or indirectly over the public or private network 920, to the profile service 750 for storage in the profile store 756 in association with the user. The contextual data from the server 1300 and data repository 1350 may be provided to the profile service 750 in batches, as described above, or alternatively upon the detection of individual context-generating events. In cases where data for a plurality of users registered with the server 1300 is provided to the profile service 750, it may be more efficient to transmit the high volume of contextual data generated by the users in batches to the profile service 750. In this manner, provision of at least some of the contextual data associated with the user of the electronic device 100 need not be sent from the electronic device 100 itself.

FIG. 14 illustrates possible communication flow between the electronic device 100 and the profile service 750 using the network topology of FIG. 13. The context-generating application or module at the electronic device 100 may access content or a service at the server 1300 by transmitting a request for data 1400. Access might include retrieval of messages (if the server 1300 is a message server), retrieval or uploading of a file, accessing a corporate directory, and so forth. The server 1300 responds 1410 to the request; for example, by transmitting the requested message to the electronic device 100. The server 1300 then also transmits contextual data as a profile update 1420 to the profile service 750, to update the user profile corresponding to the electronic device 100. The profile agent 700 at the electronic device 100 in this case need not communicate directly with the profile service 750. Other contextual data derived from sensor data collected at the electronic device 100, is still transmitted by the profile agent 700 at the device 100.

The foregoing generally describes the manner in which contextual data is mined at the electronic device 100 or a service for the electronic device 100 for provision to the profile service 750. The profile service 750, having received contextual data for a given user, can then construct a profile representing that user. Once the profile is constructed, additional contextual data may be generated for that user through the user's interaction with applications at the device 100 and from sensor data, and provided to the profile service 750 to continually update the user profile; this data may be provided generally as described above. Thus, the bulk of the contextual data provided to the profile service 750 to generate or update a profile for the user is generally derived from observational data: user interaction with electronic device applications 150, and sensor data reflecting the state of the electronic device 100. In some example embodiments, additional data may be received by means of direct feedback from the user when the profile is applied to generate action cues for the user. For example, if the profile is used to generate recommendations for the user in a search or recommender application (e.g., to search for a restaurant matching the user's preferences), the application may be configured to receive express feedback regarding the recommendations (such as the user's pre-set preferences for specific types of cuisine and dietary restrictions, or the user's input rating for a recommended restaurant). This direct feedback may be provided by the application directly to the profile service 750, or to the profile agent 700 for transmission in an update message to the profile service 750.

It will be appreciated by those skilled in the art that the supply of contextual data from the electronic device 100 and the use of a random construction of factor graphs provide an efficient learning mechanism for determining the functional form of individual factors, without relying on a domain expert to supply expertise to define the factors or to even identify domain knowledge factors for use in developing factor graphs for any subject matter. As contextual data is continually or intermittently received from the electronic device 100, the profile service 750 receives sets of context data including application data, sensor data, and/or device state data that define individual user preferences that can be used to further define factors.

For example, the profile agent 700 may supply to the service 750 context data sets describing the state of the device 100 and the environment and geographic location as may be determined by sensor data, at the time a user invokes a search application to search for a particular term, or selects a particular music file to play back. These data sets can then be applied by the profile service 750 as a complete set of variables for a factor graph constructed (at random, in accordance with the example embodiment above, but taking the context data set as the set of variables to be applied to the factor graph) to “train” the user profile, by modifying any individual factors, to reflect the new observables received from the profile agent 700. Thus, over time, with the receipt of additional context data from the electronic device 100 improves the accuracy of the factors, including any factors that might be generally considered to be “domain knowledge” and traditionally within the purview of a domain expert. Because the foregoing example embodiments rely on random construction of a factor graph, and random selection and connection of individual factors, the development and refinement of the functional forms of the factors can occur organically as additional context data sets are provided to the profile service 750, without intercession by expert knowledge or additional resources committed to hand-coding factor graph structures.

It will thus also be appreciated that larger volumes of data may benefit the foregoing system in refining the various factors stored at the profile service. It can be seen that the above example embodiments can be applied to a collective of individual users and their electronic devices 100; context data of the same types described above may be aggregated from a plurality of reporting electronic devices 100, such as all subscribers of a service provider, and applied to any factor graph that might be constructed at the profile service 750 to further refine one or more factors of the graph. Thus, aggregated data received from one set of users may be used to improve a factor used in factor graphs constructed for a different user. The use of random coding in developing the factor graphs thus provides an efficient mechanism for taking advantage of the inter-user synergy obtained through use of data across a large number of users.

The continual or intermittent refinement of functional factor forms may be applied not only to user knowledge factors and domain knowledge factors, but also to domain knowledge factors associated with individual second entities, such as the individual music files in the examples of FIGS. 4 and 4A above. While the domain knowledge factors applied to individual second entities, such as songs, may initially be similar (or assumed to be similar), with the continued application of training context data received from the electronic device 100 the functional forms of individual factors associated with individual songs may diverge, thus providing a more accurate portrayal of individual entities by the profile service 750.

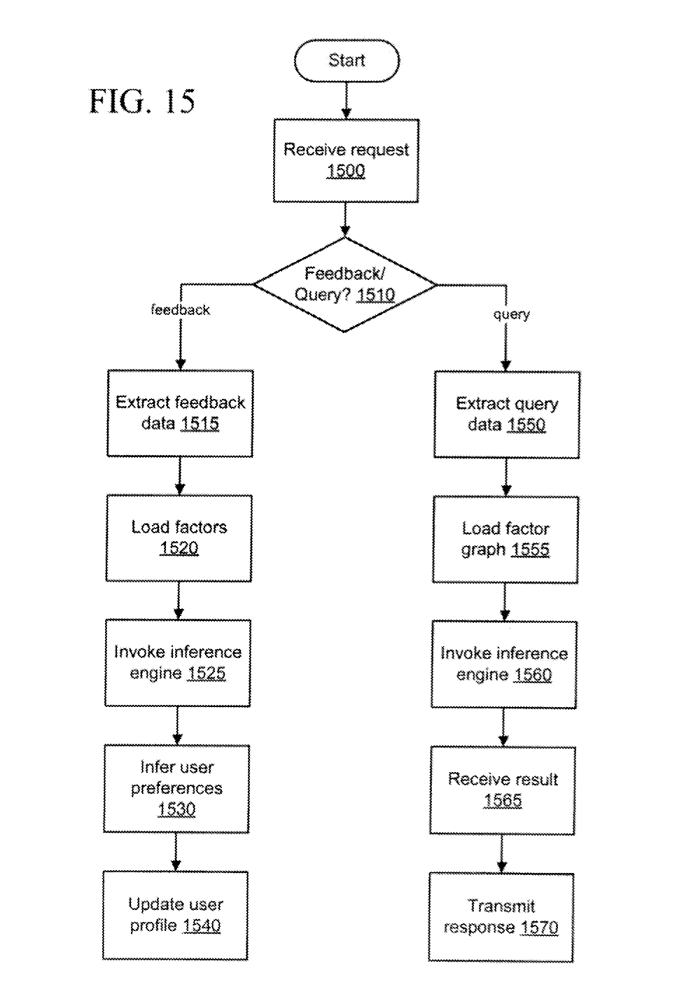

FIG. 15 illustrates a general method for issuing queries from the electronic device 100 to the profile service 750, and for providing “feedback” (i.e., training data sets of contextual data for use in refining functional forms of factors) and updating the user profile at the service 750. A query is transmitted from the electronic device 100. The query may initiate at an executing application or from the operating system 140; for example, the query may be a request for a song recommendation for use in initiating playback at the electronic device 100. In some example embodiments, the request may not come from the electronic device 100, but on behalf of the device 100 or the user. For example, a remote messaging server 1300 may be configured, upon receipt of an incoming message, to request an indication whether the message should be marked as important for the user.

The transmitted request will thus typically include some input data, such as a context value or parameter for use by the profile service in generating a response cue. The context value may be as simple as the local time of day or geographic location, or even simply an identifier of the requesting application (e.g., the media player). In the case of a request to prioritize an email or other data item, the request may include metadata regarding that item. The request will typically also include a form of user identifier or electronic device 100 identifier, and may include a token or a key to confirm that the request was generated by an authorized application or device.

At 1500 the request is received. At 1510, after receipt of the request, it is determined whether the request received from the requesting device does in fact include a query or is simply a submission of feedback data to further refine the user profile. If the request is a query, then at 1550 the query data (i.e., the input data described above) is extracted from the received request. At 1555, the appropriate factor graph(s) for the request are retrieved and/or defined. It may be, for example, that the factor graph has not yet been defined, but factors relating to the user profile are available from the profile store 756. The factor graph may then be constructed as described above. The factor graphs may be stored in an appropriate data format in the profile store 756, such as in a serialized format, or alternatively in arrays representing probability distributions that are associated with the various characteristics defined for the relevant entity. For ease in updating factors in view of received feedback, described below, the individual factors are stored discretely, and their interrelationships (as reflected by the variables connecting the different factors) are also stored. If necessary, the factor graphs are then merged, although the merging step may be accomplished during execution of the message-passing algorithm or other solution method for deriving a probability vector for the target variable that is being solved.

At 1560, an inference engine 758 is invoked by the profile service to solve for the variable requested. The inference engine makes use of any variable values that are provided in the request, if any, in computing the probabilities associated with all variables in the facto graph, including any “hidden” variables for which the request did not provide values. In the case of the music file recommendation problem identified above, the variable of interest would be the vector of probability values associated with the Song ID. This result is obtained at 1565, at which point the profile service 750 may then identify one or more of the most appropriate solutions. For example, if the inference engine solves for a vector identifying a plurality of second entities, only those ones corresponding to the higher values in the solved vector—those entities having the highest values (e.g., the highest ten or twenty values), or only those values equal to or above a threshold value, such as 70%, may be retrieved. In other circumstances, only the highest-ranked entity is selected. The entity identity or identities are retrieved, and returned in a response to the electronic device 100 at 1570. The response includes a cue that is then used by the electronic device 100 in an action executed at the device. Depending on the nature of the query, the response may simply be a binary indicator (e.g., a flag indicating whether a message is important or not), a file identifier (e.g., a music file identifier), or a more complex response, such as a listing of search results.

A method for handling such feedback is also illustrated in FIG. 15. A query received by the profile service 750 intended for feedback will typically include a number of observable values, optionally for every relevant variable in a given factor graph. In the example of the music recommendation, the query may include sensor data and application data, including the identifier of the song currently playing; time of day; current weather; artist, genre, BPM and ratings information; and so forth. At 1510, if it is determined that the request received at the server is to provide feedback, at 1515 the feedback data is extracted from the query and the appropriate factors, or the entire factor graph, are loaded at 1520. It is not necessary to load the entire factor graph in the feedback data received relates only to one factor; only those factors connected to the variables corresponding to the feedback data need to be retrieved. The inference engine is then invoked at 1525, and based on the feedback values received, new values for the retrieved factors are inferred at 1530, reflecting the newly received information. At 1540, the updated factors are stored, thus updating the corresponding user profile. Similarly, if feedback is received that can be applied to any other portion of a factor graph, which can include domain knowledge factors or public knowledge, only those factors of the appropriate factor graph need be retrieved and adjusted. Again, in some example embodiments the feedback handling method may be executed at the requesting device instead. Feedback processing may be carried out asynchronously; for example, data collected by the profile agent 700 may be, as described previously, uploaded to the profile service 750 in batches rather than on an ad hoc basis.

In the example embodiments of FIG. 7 and FIG. 8, the profile agent 700 includes a trust manager component 710. The trust manager component 710 may be implemented to restrict access to the profile service 750 only to authorized programs 150 or operating system 140 modules. Thus, unauthorized applications that are not registered with the trust manager 710 will be unable to make requests for recommendations or action cues from the profile service 750 or 850. Still further, an access policy for the profile service 750 may be administered by the trust manager 710, such that requests initiated by various applications at the electronic device 100 are vetted by the trust manager 710 prior to transmission to the profile service 750. For example, when an application is registered with the trust manager 710, it registers as a certain application type (messaging client, media player, word processor, browser, and so forth). Requests for cues received from that application are then restricted by the trust manager 710 only to subject matter relating to the application type: a messaging client may be permitted to issue requests limited to handling of messages or contacts.

In another example embodiment, when an application registers with the trust manager 710, the application may be required to declare its profiling activities with the trust manager 710. A photo viewer application, for example, may declare that it intends to log graphics files together with metadata including GPS location, timestamp, and facetags when available. The user may be requested by the trust manager 710 to confirm that the photo viewer application is to be granted this access with varying levels of granularity (e.g., timestamp only, or no facetags). The trust manager 710 may be configured to provide a security rating indication to the user of the pervasiveness of the privileges sought by the application: for example, a security relating of “green” or “low” may indicate that the application is requesting only a few logging privileges, or is requesting privileges for metadata or data of the type that the user has already granted (such as timestamp or GPS location, if the user had already granted another application permission to log timestamps and locations). Upon user confirmation of the privileges granted to the requesting application, the trust manager 710 can then issue a privilege-granting token to the application that must then be included by the application in all future requests.

Similarly, when an application declares an intention to query the profile service 750 for certain data (for example, to request identification of faces in photographs for inclusion as tags in the graphics files), the user may be requested to confirm these access privileges as well.

The systems and methods disclosed herein are presented only by way of example and are not meant to limit the scope of the subject matter described herein. Other variations of the systems and methods described above will be apparent to those in the art and as such are considered to be within the scope of the subject matter described herein. For example, it should be understood that steps and the order of the steps in the processing described herein may be altered, modified and/or augmented and still achieve the desired outcome. Throughout the specification, terms such as “may” and “can” are used interchangeably and use of any particular term should not be construed as limiting the scope or requiring experimentation to implement the claimed subject matter or example embodiments described herein.

The systems' and methods' data may be stored in one or more data stores. The data stores can be of many different types of storage devices and programming constructs, such as RAM, ROM, flash memory, programming data structures, programming variables, etc. It is noted that data structures describe formats for use in organizing and storing data in databases, programs, memory, or other computer-readable media for use by a computer program.

Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. Various functional units described herein have been expressly or implicitly described as modules and agents, in order to more particularly emphasize their independent implementation and operation. It is also noted that an agent, module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The various functional units may be implemented in hardware circuits including custom VLSI circuits or gate arrays; field-programmable gate arrays; programmable array logic; programmable logic devices; commercially available logic chips, transistors, and other such components. Modules implemented as software for execution by a processor or processors may include one or more physical or logical blocks of code that may be organized as one or more of objects, procedures, or functions. The modules need not be physically located together, but may include code stored in different locations, such as over several memory devices, capable of being logically joined for execution. Modules may also be implemented as combinations of software and hardware, such as a processor operating on a set of operational data or instructions.

A portion of the disclosure of this patent document contains material which is or may be subject to one or more of copyright, design patent, industrial design, or unregistered design protection. The rightsholder has no objection to the reproduction of any such material as portrayed herein through facsimile reproduction of the patent document or patent disclosure, as it appears in the Patent and Trademark Office patent file or records, but otherwise reserves all rights whatsoever.

1. A method, comprising:
defining a profile for an electronic device using context data aggregated from at least one electronic device and a plurality of domains and including at least one of sensor data, device state data, and application data, the profile including a representation of a probability distribution for the electronic device;
identifying, using the profile, a user-initiable command associated with at least one application for implementation at the electronic device; and
providing a parameter associated with the user-initiable command cue for the action to the electronic device.

2. (canceled)

3. The method of claim 1, wherein the context data includes two or more of sensor data, device state data, and application data.

4. The method of claim 1, wherein the plurality of domains is selected from a messaging domain, a social networking domain, a consumer preference domain, and an environmental domain.

5. The method of claim 1, wherein the application data is selected from search application search terms, contacts, message keywords, social networking post keywords, weather forecast data, application identifiers, message senders, message recipients, message characteristics, message handling data, and media files selected for playback.

6. The method of claim 1, wherein the sensor data is selected from geographic location data, ambient light, time of day, accelerometer data, and proximity sensor data.

7. The method of claim 1, wherein the device state data is selected from battery level, wireless network connection, radio state, attachment of peripherals, screen brightness, speaker volume, data transfer levels, docked state, and charging state.

8. The method of claim 1, wherein the context data includes historical data.

9. The method of claim 1, wherein the representation of the probability distribution includes a factor graph representation having factors dependent on at least one of a set of characteristic variables associated with the electronic device.

10. The method of claim 9, wherein defining the factor graph representation comprises:
adding to the factor graph representation a selected one of the factors, the selected factor having a degree d;
selecting d of the set of characteristic variables and connecting the d characteristic variables to at least one of the factors added to the factor graph; and
repeating the adding and selecting until each of the factors is connected to a number of characteristic variables equal to its degree.

11. The method of claim 10, wherein the selected one of the factors is a factor having a high probability of a low degree d.

12. The method of claim 10, wherein selecting d of the set of characteristic variables comprises preferentially selecting those characteristic variables that are either currently unconnected or have low connectivity to the at least one of the factors currently added to the factor graph.

13. The method of claim 10, wherein at least one of the selected factor and the d of the set of characteristic variables is randomly selected.

14. The method of claim 1, wherein identifying the one of the plurality of actions includes inferring the one of the plurality of actions using the profile and at least one received context value associated with the electronic device.

15. The method of claim 14, wherein the at least one received context value is either a sensor value or a device state value.

16. The method of claim 1, wherein the application associated with the identified action includes a media player, and the action includes the media player playing a selected media file.

17. The method of claim 1, wherein the application associated with the identified action includes a messaging application, and the action includes marking a received message as important.

18. The method of claim 1, wherein the application associated with the identified action includes a search application, and the action includes initiating a search with a selected search parameter.

19. The method of claim 1, wherein the context data is aggregated from a domain or domains other than a domain associated with the application associated with the identified action.

20. (canceled)

21. (canceled)

22. An electronic device, comprising:
a memory;
a communication subsystem; and
at least one processor in communication with the memory and the communications subsystem, adapted to:
define a profile for an other electronic device using context data aggregated from at least one electronic device and a plurality of domains and including at least one of sensor data, device state data, and application data, the profile including a representation of a probability distribution for the other electronic device;
identifying, using the profile, a user-initiable command associated with at least one application for implementation at the other electronic device; and
providing a parameter associated with the user-initiable command for the action to the other electronic device.

23-40. (canceled)

41. A non-transitory computer-readable medium bearing code which, when executed by at least one processor of an electronic device, causes the electronic device to:
define a profile for an other electronic device using context data aggregated from at least one electronic device and a plurality of domains and including at least one of sensor data, device state data, and application data, the profile including a representation of a probability distribution for the other electronic device;
identifying, using the profile, a user-initiable command associated with at least one application for implementation at the other electronic device; and
providing a parameter associated with the user-initiable command for the action to the other electronic device.
